(19) United States
(12) Patent Application Publication
(10) Pub. No.: US 2026/0363368 A1
(43) Pub. Date: Nov. 19, 2026

(54) USE OF PROTECTIVE MATERIAL AND PROTECTIVE CLOTHING AGAINST CONTAMINATION BY POLYCYCLIC AROMATIC HYDROCARBONS

(71) Applicant: Blücher GmbH, Erkrath (DE)

(72) Inventors: Brigitte BAGGEN, Erkrath (DE); Sarah VOGT, Erkrath (DE); Andreas ARNOLD, Erkrath (DE)

(21) Appl. No.: 19/136,378

(22) PCT Filed: Dec. 3, 2023
(86) PCT No.: PCT/EP2023/084240

§ 371 Date: Jun. 6, 2025

(30) Foreign Application Priority Data
Dec. 6, 2022 (DE) 102022132360.9
Dec. 21, 2022 (DE) 102022134282.4

(51) Int. Cl. A41D 13/02; A41D 31/04; B32B 5/02; B32B 5/16; B32B 5/26; B32B 5/30; B32B 7/12

(52) U.S. Cl. CPC A41D 13/02; A41D 31/04; B32B 5/022; B32B 5/16; B32B 5/266; B32B 5/30; B32B 7/12; B32B 2264/10; B32B 2307/54; B32B 2307/724; B32B 2307/7376; B32B 2437/00

(57) ABSTRACT

The present invention relates to the use of a protective clothing, preferably in the form of a protective undergarment (protective underwear), for protecting persons against exposure to and/or contamination with polycyclic aromatic hydrocarbons (PAHs) released from a contamination source when staying and/or working in locations in which polycyclic aromatic hydrocarbons are released or present, and/or for protecting persons exposed to polycyclic aromatic hydrocarbons against contamination (“PAH contamination”), in which polycyclic aromatic hydrocarbons are released or present, and/or to protect persons exposed to polycyclic aromatic hydrocarbons against contamination (“PAH contamination”), especially to prevent or minimize contamination (“PAH contamination”).

### CROSS-REFERENCES TO RELATED APPLICATIONS

This application is a National Stage filing of International Application PCT/EP2023/084240, filed Dec. 5, 2023, entitled ““USE OF PROTECTIVE MATERIAL AND PROTECTIVE CLOTHING AGAINST CONTAMINATION BY POLYCYCLIC AROMATIC HYDROCARBONS”, claiming priority to DE 10 2022 132 360.9, filed Dec. 6, 2022, and DE 10 2022 134 282.4 filed Dec. 21, 2022. The subject application claims priority to PCT/EP2023/084240, DE 10 2022 132 360.9, and DE 10 2022 134 282.4 and and incorporates all by reference herein, in their entirety.

### BACKGROUND OF THE INVENTION

The present invention relates to the technical field of textile protective materials or textile protective clothing for protection against contamination by polycyclic aromatic hydrocarbons (also referred to synonymously as “polycyclic aromatic hydrocarbons” or abbreviated as “PAH” or “PAHs”).

The present invention especially relates to the use of a textile protective clothing, preferably in the form of a textile protective undergarment (i.e. protective underwear), for protecting persons against exposure to and/or contamination with polycyclic aromatic hydrocarbons (PAHs) released from a contamination source when staying and/or working in locations in which polycyclic aromatic hydrocarbons are released or present, and/or for protecting persons exposed to polycyclic aromatic hydrocarbons against contamination (“PAH contamination”), especially for preventing or minimizing contamination (“PAH contamination”).

Furthermore, the present invention relates to the use of a textile protective material, especially in the form of a (textile) protective clothing, preferably in the form of a protective undergarment (protective underwear), for preventing or minimizing contamination with polycyclic aromatic hydrocarbons released from a contamination source (“PAH contamination”), especially for protecting persons exposed to polycyclic aromatic hydrocarbons (PAHs).

Furthermore, the present invention relates to a method for protecting persons against exposure to and/or contamination with polycyclic aromatic hydrocarbons (PAHs) released from a contamination source when staying and/or working in locations in which polycyclic aromatic hydrocarbons are released or present, and/or for protecting persons exposed to polycyclic aromatic hydrocarbons against contamination (“PAH contamination”), especially for preventing or minimizing contamination (“PAH contamination”).

Finally, the present invention relates to a protective clothing combination and its use for protecting persons against exposure to and/or contamination with polycyclic aromatic hydrocarbons (PAHs) released from a contamination source when staying and/or working in locations in which polycyclic aromatic hydrocarbons are released or present, and/or for the protection of persons exposed to polycyclic aromatic hydrocarbons against contamination (“PAH contamination”), especially for the prevention or minimization of contamination (“PAH contamination”) and/or for the prevention or minimization of contamination with polycyclic aromatic hydrocarbons released from a contamination source (“PAH contamination”), preferably for the protection of persons exposed to polycyclic aromatic hydrocarbons (PAHs).

Polycyclic aromatic hydrocarbons or polycyclic aromatic hydrocarbons (synonymously abbreviated as “PAH” or “PAHs” or occasionally also referred to as “PAH”, derived from the English “polycyclic aromatic hydrocarbons”) is the name for a group of substances consisting of well over a hundred individual substances. PAHs are contained in large quantities in coal, tar and pitch, but are also found in significant quantities in exhaust gases or flue gases from combustion and/or high-temperature processes (e.g. in fire smoke or in exhaust gases or combustion gases from coking plants, steelworks, metal smelting plants, blast furnaces, etc.). They are especially formed during the incomplete combustion of organic substances and materials.

The polycyclic aromatic hydrocarbons thus form a group of organic compounds which consist of at least two connected, i.e. condensed aromatic ring systems, wherein the ring-shaped hydrocarbons can also carry substituents. This results in a great wealth of variants within the PAHs, wherein several hundred compounds are known. PAHs are predominantly neutral and non-polar solids with only low water solubility. Numerous PAHs have been proven to be carcinogenic (i.e. cancer-causing), especially as they are epoxidized during metabolization in the body and the resulting epoxides can react with human DNA in a nucleophilic ring-opening reaction.

In terms of occupational health and safety, the reference or lead substance in this group of substances is benzo[a]pyrene. Benzo[a]pyrene (synonymously also referred to as “1,2-benzpyrene”) is a polycyclic aromatic hydrocarbon and is found, for example, in coal tar, but is also formed during the incomplete combustion of organic materials and substances and is therefore very common (e.g. in car and industrial exhaust fumes, but also in cigarette smoke and in the roasted aroma of coffee beans, as well as in barbecue products prepared over charcoal or pine cones, but above all in exhaust gases or flue gases from combustion and/or high-temperature processes, such as fire smoke, exhaust gases from coking plants, steelworks, metal smelting plants, blast furnaces, etc.), Benzo[a]pyrene is considered to be carcinogenic, mutagenic to germ cells and toxic to reproduction.

With regard to occupational health and safety, corresponding restrictions on use and additional guidelines apply from a benzo[a]pyrene content of more than 50 mg/kg, namely special technical rules for hazardous substances (so-called TRGS) of the Federal Institute for Occupational Safety and Health, such as especially the guidelines TRGS 551 and TRGS 524. The occupational acceptance concentration is 70 ng/m³ and the occupational tolerance concentration is 700 ng/m³. Diseases caused by PAHs during the performance of an occupational activity (such as mucosal changes, cancer or other tumors, especially of the urinary tract) as a result of contamination with polycyclic aromatic hydrocarbons are recognized as occupational diseases in Germany upon application if there is evidence of exposure to a cumulative dose of at least 80 benzo[a]pyrene-years (see e.g. List of Occupational Diseases). List of occupational diseases in Germany, Annex 1 to the Ordinance on Occupational Diseases (BKV) in the version of the Fifth Ordinance amending the Ordinance on Occupational Diseases of Jun. 29, 2021).

In the case of PAH-contaminated environments, the undesired absorption of PAHs into the body occurs through the air we breathe or via the respiratory organs, but also through the skin and hair.

Firefighters especially are exposed to high levels of PAHs during the course of their careers: In the event of an emergency, these firefighters are directly exposed to fire smoke. Fire smoke is a mixture of different chemical substances, which can vary greatly depending on the location of the fire; fire smoke always contains substances from the group of so-called polycyclic aromatic hydrocarbons, wherein these polycyclic aromatic hydrocarbons have different carcinogenic effects and can also be absorbed into the body through the skin and hair. In Germany alone, there are 40,000 full-time and 1.3 million volunteer firefighters.

As explained above, these firefighters are directly exposed to fire smoke in the event of an emergency, wherein protective outer wear, especially protective outer clothing, preferably personal protective equipment (PPE), especially in the case of firefighters protective outer clothing in accordance with DIN EN 469, is worn in addition to respiratory protective equipment to protect against the fire smoke, especially against contamination with the toxic substances contained therein.

DIN EN 469 (current version: DIN EN 469:2020) entitled “Schutzkleidung für die Feuerwehr—Leistungsanforderungen für Schutzkleidung für Tätigkeiten der Feuerwehr” regulates the quality of protective outerwear for firefighters for firefighting; especially, this regulation focuses on the performance requirements of firefighting outerwear, i.e. resistance or behavior of the clothing during firefighting operations (especially exposure of the material to flames or thermal radiation and heat). However, the prevention of the penetration of toxic substances, especially PAHs, is not addressed at all.

However, firefighting operations, especially fires, almost always result in the formation of a large number of hazardous substances, regardless of the materials involved in the fire; depending on the design of the affected fire object or the building or materials used, particles such as soot, dust and fibers are released in addition to fire or smoke gases. The basic composition of fire smoke and its hazard classification are well known from extensive studies.

In the event of a fire, the following hazardous substances are generally released: acutely and chronically toxic substances (e.g. carbon monoxide, hydrogen cyanide, styrene, hydrochloric acid, hydrogen chloride, etc.) on the one hand and carcinogenic substances (e.g. benzene, polycyclic aromatic hydrocarbons, etc.) on the other.

As with any exposure to hazardous substances, there are several ways in which fire smoke and other combustion products and residues as well as the associated hazardous substances, bio-substances and other dangerous substances can enter the body, namely through incorporation, i.e. through direct intake of hazardous substances into the body, e.g. through inhalation, ingestion or through the skin (absorption), or through contamination, i.e. contact with contaminated surfaces or objects, such as personal protective equipment or other equipment, but also with the skin itself.

Many of the hazardous substances present or produced during a fire, especially PAHs, are skin-resorptive. Although a large proportion of these hazardous substances are kept out by the protective outer clothing, these hazardous substances are deposited on it and also penetrate through the protective outer clothing to a certain extent, so that they ultimately come into contact with the skin and hair, from where they can be absorbed into the body.

However, the hazardous substances contained in fire smoke, especially the aforementioned PAHs, are not only produced in gaseous form at high temperatures, as in the event of a fire, but can also adhere to the dust and soot particles released in the event of a fire and bind to them, so that they remain on the protective outerwear even after the fire has ended. Pollutant particles that have penetrated the protective outerwear (i.e. dust or soot particles loaded with PAHs) can also get onto the skin and the PAHs bound to them can be absorbed from there into the body.

So far, however, the state of the art lacks an efficient solution to prevent the penetration of PAHs (both in gaseous form and in particle-bound form) through protective outerwear.

However, many other combustion and high-temperature processes also produce gases containing polycyclic aromatic hydrocarbons, especially exhaust gases or flue gases, for example in coking plants, foundries and steelworks, in smelting processes, in metal and steel production and processing processes, in blast furnace processes, in waste incineration processes, in asphalt production and processing processes, in glass production and processing processes, in refractory production and processing processes, etc. People who are present in the relevant locations or working in the relevant processes, especially for the purpose of carrying out their work, are therefore subject to increased exposure and contamination with polycyclic aromatic hydrocarbons, which, due to the extremely high temperatures of these processes, are released both in gaseous form and in particulate form (e.g. dust or soot particles). This means that both the gaseous PAHs and the PAHs bound to particles can be absorbed into the body not only via the respiratory tract, but also via the skin and hair.

In general, however, the protective outerwear usually used for the aforementioned activities, especially protective workwear, especially personal protective equipment (PPE), such as protective outerwear for firefighters in accordance with DIN EN 469:2020, is not sufficient to prevent the penetration of PAH-containing contaminants either in gaseous form or in a form bound to particles (such as dust, soot or flue gas particles) and consequently prevent them from reaching the skin, resulting in significant exposure and contamination of the skin with PAHs and, as a result, undesirable PAH absorption through the skin. As the PAHs remain on the protective outerwear in particle-bound form even after exposure, there is a risk of subsequent contamination of the skin via the protective outerwear even after exposure.

So far, however, despite knowledge of exposure to PAH contamination in the areas concerned, there has been a lack of a solution concept to efficiently prevent or at least minimize unwanted penetration of the protective outerwear with PAHs to the wearer's skin. As exposure to polycyclic aromatic hydrocarbons often occurs in very hot locations or when the wearer of such protective outerwear is already under high thermal stress, it has not been possible to date to provide additional protective equipment against the penetration of PAHs, as this would lead to additional and therefore intolerable thermal stress on the wearer during use.

### BRIEF SUMMARY OF THE INVENTION

Against this background, one object of the present invention is therefore to provide an efficient and economical concept for protecting persons against exposure to and/or contamination with polycyclic aromatic hydrocarbons (PAHs) released from a contamination source when staying and/or working in locations in which polycyclic aromatic hydrocarbons are released or present, or for protecting persons exposed to polycyclic aromatic hydrocarbons against contamination with PAHs (“PAH contamination”), especially for preventing or minimizing contamination with PAHs (“PAH contamination”), respectively, wherein this concept is especially intended to at least largely avoid or at least minimize or mitigate the problems and disadvantages of the prior art described above.

A further object of the present invention is to provide an efficient and economical concept for protecting persons against exposure to and/or contamination with polycyclic aromatic hydrocarbons (PAHs) released from a contamination source when staying and/or working in locations in which polycyclic aromatic hydrocarbons are released or present, or to protect persons exposed to polycyclic aromatic hydrocarbons against contamination with PAHs (“PAH contamination”), especially to prevent or minimize contamination with PAHs (“PAH contamination”), respectively, wherein this concept should be implementable or realizable in combination with protective outerwear, especially protective workwear, preferably personal protective equipment (PPE), existing or customary in the area concerned. Especially, the inventive concept should be compatible and/or complementary with respect to an existing or customary protective outerwear, especially protective workwear, preferably personal protective equipment (PPE), in the relevant area.

Finally, another object of the present invention is to provide an efficient and economical concept for protecting persons against exposure to and/or contamination with polycyclic aromatic hydrocarbons (PAHs) released from a contamination source when staying and/or working in locations in which polycyclic aromatic hydrocarbons are released or present, or to protect persons exposed to polycyclic aromatic hydrocarbons against contamination with PAHs (“PAH contamination”), especially to prevent or minimize contamination with PAHs (“PAH contamination”), respectively, wherein the concept should also be implementable or realizable as subsequent and/or complementary equipment in relation to protective outerwear, especially protective workwear, preferably personal protective equipment (PPE), existing or customary in the area concerned. Especially, it should be possible to supplement or retrofit existing or customary protective concepts in the relevant field with the inventive concept, especially with the aim of providing additional and/or complementary PAH protection.

Finally, a further object of the present invention is to provide an efficient and economical concept for protecting persons against exposure to and/or contamination with polycyclic aromatic hydrocarbons (PAHs) released from a contamination source when staying and/or working in locations in which polycyclic aromatic hydrocarbons are released or present, or for protecting persons exposed to polycyclic aromatic hydrocarbons against contamination with PAHs (“PAH contamination”), especially for preventing or minimizing contamination with PAHs (“PAH contamination”), respectively, wherein the concept is intended to entail no or no significant (additional) stress (such as thermal stress, lack of wearing comfort, restriction of freedom of movement, etc.) for the persons to be protected. The inventive concept is especially intended to ensure a high level of wearing comfort while at the same time providing excellent protection against PAHs.

To solve the object described above, the present invention thus proposes—according to a first aspect of the present invention—the use of a protective clothing, preferably in the form of a protective undergarment (protective underwear); further, respectively advantageous further embodiments and configurations of this aspect of the invention are provided.

Again, a further object of the present invention-according to a second aspect of the present invention—is the use of a textile protective material, especially in the form of a protective clothing, preferably in the form of a protective undergarment (protective underwear), according to advantageous further embodiments and configurations of this aspect of the invention.

In addition, a further object of the present invention—according to a third aspect of the present invention—is also a method relating thereto.

Similarly, another object of the present invention—according to a fourth aspect of the present invention—is also a protective clothing combination, especially for protecting persons against exposure to and/or contamination with polycyclic aromatic hydrocarbons (PAHs) released from a contamination source when staying and/or working in locations in which polycyclic aromatic hydrocarbons are released or present, and/or especially to protect persons exposed to polycyclic aromatic hydrocarbons against contamination (“PAH contamination”), especially to prevent or minimize contamination (“PAH contamination”) and/or especially to prevent or minimize contamination with polycyclic aromatic hydrocarbons released from a contamination source (“PAH contamination”), preferentially for protecting persons exposed to polycyclic aromatic hydrocarbons (PAHs).

Finally, yet another object of the present invention—in accordance with a fifth aspect of the present invention—is also the use of the protective clothing combination according to the disclosure herein; further, respectively advantageous further embodiments and configurations of this aspect of the invention are provided.

It goes without saying that in the following description of the present invention, such embodiments, configurations, advantages, examples or the like which—for the purpose of avoiding unnecessary repetition—are set out below only in relation to a single aspect of the invention, naturally also apply correspondingly in relation to the other aspects of the invention, without the need for express mention of this.

Furthermore, it goes without saying that in the following specifications of values, figures and ranges, the relevant specifications of values, figures and ranges are not to be understood as limiting; it goes without saying for the person skilled in the art that it is possible to deviate from the specified ranges or specifications on a case-by-case or application-related basis without departing from the scope of the present invention.

In addition, all the values or parameters or the like stated below can in principle be determined using normed or standardized or explicitly stated determination methods or otherwise using determination or measurement methods known to a person skilled in the art in this field. Unless otherwise stated, the underlying values or parameters are determined under standard conditions (i.e. especially at a temperature of 20 °C and/or at a pressure of 1,013.25 hPa or 1.01325 bar).

Furthermore, it should be noted in the case of all the relative or percentage, especially weight-related, quantities given below, that these details are to be selected or combined by the person skilled in the art within the scope of the present invention in such a way that the total—if necessary including further components or ingredients, especially as defined below—always results in 100% or 100 wt.-%. However, this is self-evident to the person skilled in the art.

### BRIEF DESCRIPTION OF THE DRAWINGS

FIG. 1 a cross-sectional representation of a protective clothing 8 used according to the invention or a protective material 1 used according to the invention in accordance with a particular embodiment of the invention, wherein the protective clothing 8 or the protective material 1 in the sequence shown in FIG. 1 has a textile support layer 2, an adhesive layer 3, an adsorption layer 4 with a plurality of individual adsorber particles 4a, a particle and/or aerosol filter layer 5, an optional cover layer 6 and an also optional further or second cover layer 7;

FIG. 2A a partial cross-sectional view of a protective clothing 8 used according to the invention or of a textile protective material 1 used according to the invention (namely only to the extent of textile support layer 2, adhesive layer 3 and adsorption layer 4 with a plurality of individual adsorber particles 4a) according to a first particular and alternative to FIG. 2B embodiment of the invention, according to which the adhesive layer 3 and/or the adhesive of the adhesive layer 3 is applied to and/or provided onto the textile support layer 2 as a water vapor-permeable and/or air-permeable, preferentially water vapor- and air-permeable, and/or discontinuously formed adhesive layer based on a dried and/or cured, especially crosslinked, broken adhesive polymer foam;

FIG. 2B a partial cross-sectional view of a protective clothing 8 used according to the invention or of a textile protective material 1 used according to the invention (namely only to the extent of textile support layer 2, adhesive layer 3 and adsorption layer 4 with a plurality of individual adsorber particles 4a) according to a second special and alternative to FIG. 2A embodiment of the invention, wherein the adhesive layer 3 and/or the adhesive of the adhesive layer 3 is applied to and/or provided onto the textile support layer 2 as a water vapor and/or air permeable, preferentially water vapor and air permeable, and/or discontinuously formed adhesive layer based on an adhesive polymer, wherein the adhesive layer is configured in the form of a grid of a plurality of individual (i.e. non-contiguous or non-bonded) adhesive (polymer) dots distributed over the support layer 2;

FIG. 3 a schematic representation of a protective clothing 8 used in accordance with the invention, according to a particular embodiment of the invention, wherein the protective clothing 8 is present and/or configured as a protective leg garment 8a, especially protective trousers, and/or as a protective top garment 8b, especially protective shirt, protective T-shirt or protective sweater, especially including covering of the arms, and/or as a protective headwear 8c, especially protective head cover or protective balaclava, especially wherein the protective clothing 8 is preferably present and/or configured as a combination of (i) protective leg garment 8a, especially protective trousers, (ii) protective top garment 8b, especially protective shirt, protective T-shirt or protective sweater, especially including covering of the arms, and (iii) protective headwear 8c, especially protective head cover or protective balaclava.

### DETAILED DESCRIPTION OF THE INVENTION

Having said this, the present invention will be described and explained in more detail below, also with reference to drawings and figures illustrating preferably embodiments or examples of embodiments.

The object of the present invention-according to a first aspect of the present invention-is thus the use of a protective clothing, preferably in the form of a protective undergarment (protective underwear), for protecting persons against exposure to and/or contamination with polycyclic aromatic hydrocarbons (PAHs) released from a source of contamination when staying and/or working in locations in which polycyclic aromatic hydrocarbons are released or present, and/or for protecting persons exposed to polycyclic aromatic hydrocarbons against contamination (“PAH contamination”), especially to prevent or minimize contamination (“PAH contamination”),
wherein the protective clothing comprises or is formed from a textile protective material,
wherein the textile protective material is configured as a multi-layered textile composite material comprising a plurality of interconnected layers,
wherein the textile protective material comprises the following layers, preferably in the sequence mentioned below:
(a) a textile support layer, wherein the textile support layer is present and/or configured as a preferably gas-permeable textile sheet-structure (textile fabric),
(b) an adhesive layer applied to one side of the textile support layer, wherein the adhesive layer is present and/or configured as a water-vapor-permeable and/or gas-permeable and/or discontinuously formed adhesive layer, preferentially based on an adhesive polymer,
(c) an adsorption layer fixed and/or adhered to the adhesive layer, preferentially discontinuously formed and/or gas-permeable, wherein the adsorption layer comprises or is formed from a plurality of individual adsorber particles,
(d) a particle and/or aerosol filter layer arranged on the adsorption layer and/or connected to the adsorption layer, preferentially a particle and aerosol filter layer, wherein the particle and/or aerosol filter layer is present and/or configured as a gas-permeable textile sheet-structure which comprises or is formed from a plurality of individual textile fibers,
(e) optionally a cover layer arranged on the particle and aerosol filter layer and/or connected to the particle and aerosol filter layer, wherein the cover layer is present and/or configured as a preferentially gas-permeable textile sheet-structure.

Furthermore, it can be envisaged according to the invention that the textile protective material also has a further or second cover layer arranged on the side of the textile support layer facing away from the adhesive layer and/or connected thereto, wherein the further or second cover layer is present and/or configured as a preferentially gas-permeable textile sheet-structure. In other words, it can be provided according to the invention that the textile protective material further also optionally comprises the following layer:
(f) a further or second cover layer arranged on the side of the textile support layer facing away from the adhesive layer and/or connected thereto, wherein the further or second cover layer is present and/or configured as a preferentially gas-permeable textile sheet-structure

In general, in the context of the present invention, the protective clothing and/or the protective material is/are arranged and/or used during use and/or in the state of use, especially in the state of wear, in such a way that the particle and/or aerosol filter layer and/or the optionally present cover layer faces the source of contamination and/or that the particle and/or aerosol filter layer and/or the optionally present cover layer faces away from the wearer of the protective clothing and/or that the particle and/or aerosol filter layer and/or the optionally present cover layer forms/forms an outer layer of the protective clothing and/or the protective material.

In other words, in the context of the present invention, the protective clothing and/or the protective material is/are arranged and/or used during use and/or in the state of use, especially in the state of wear, in such a way that the textile support layer and/or the optionally present further or second cover layer is/are facing away from the source of contamination and/or that the textile support layer and/or the optionally present further or second cover layer is/are facing the wearer of the protective clothing and/or that the textile support layer and/or the optionally present further or second cover layer forms/forms an inner layer of the protective clothing and/or the protective material.

In other words, when the protective clothing or protective material used in accordance with the invention is used, the aforementioned textile support layer forms the layer closest to the body or the optional cover layer or, in the absence of the cover layer, the particle and/or aerosol filter layer forms the layer furthest from the body. This means that the PAH-containing gas and/or particle stream to be decontaminated flows through the protective clothing or protective material used in accordance with the invention in the sequence or order of the aforementioned layers (e), (d), (c), (b) and finally (a).

This ensures that the released polycyclic aromatic hydrocarbons (PAHs) to be rendered harmless, which are usually present at high ambient temperatures (e.g. fire smoke) both in gaseous form and in particulate-bound form (e.g. PAH-laden soot, flue gas and dust particles), first impinge on the optional cover layer and then on the particle and/or aerosol filter layer or are brought into contact with it before the remaining PAH contaminants are brought into contact with the adsorption layer or the adsorber particles present there.

This in turn ensures that, when used in the application state (use state) according to the invention, PAH-loaded or PAH-contaminated particles (e.g. PAH-loaded dust, soot or flue gas particles through to fine and ultra-fine dust particles to which PAHs adhere) are first rendered harmless, since coarser PAH-loaded or PAH-contaminated particles are first retained by the cover layer and finer to finest PAH-loaded or PAH-contaminated particles are then retained by the subsequent particle and aerosol filter layer and rendered harmless in this way, before finally the remaining, predominantly gaseous PAH load (PAH contamination) is finally adsorbed by the adsorption layer or the adsorber particles present there and rendered harmless in this way. In this context, the adhesive layer, by means of which the adsorption layer is fixed to the textile support layer, also ensures that there is sufficient residence time and/or convection of the gaseous PAH contaminants to be adsorbed, so that no undesired PAH breakthroughs can occur through the lower textile support layer.

As the applicant has now discovered in a completely surprising way, the use of the protective clothing used in accordance with the invention, preferably in the form of a protective undergarment (=protective underwear), or the use of the protective material used according to the invention enables an efficient and economical concept for the protection of persons against exposure to and/or contamination with polycyclic aromatic hydrocarbons (PAH) released from a contamination source when staying and/or working in locations, in which polycyclic aromatic hydrocarbons are released or present, and/or for protecting persons exposed to polycyclic aromatic hydrocarbons against contamination (“PAH contamination”), especially for preventing or minimizing contamination (“PAH contamination”).

Due to the specially designed structure and composition of the protective clothing or protective material used according to the invention, especially with regard to the individual components, an efficient and economical double protective function against PAH contamination can be provided for the first time, namely in that protection against PAH contamination in solid form (e.g. against PAH-laden particles) as well as PAH contamination in gaseous form is assured or ensured.

At the same time, the specially coordinated structure of the protective clothing or protective material used in accordance with the invention, which consists of a small number of essential individual components, especially combined with a low weight per unit area and good water vapor and air permeability, ensures a high level of wearing comfort, which especially enables the use even under high physical stress (e.g. use by firefighters at fire scenes, carrying out heavy physical work under thermal stress or under the effect of heat, such as at blast furnaces, in glass manufacturing plants, in the production of refractory products). For example, firefighters working at fire scenes, carrying out heavy physical work The wearing comfort is also increased by the fact that the adsorption layer or the adsorber particles present there (preferably activated carbon particles) can also serve as a moisture or water reservoir or buffer (e.g. for body sweat). In this way, the protective clothing or protective material used according to the invention provides a multiple functionality that goes far beyond the mere protective function against PAH contamination.

In addition to the advantages and special features of the present invention shown above, the inventive concept is associated with a large number of further advantages and special features, of which—in a non-exhaustive manner—some essential ones are listed below, without the present invention having to be limited thereto.

A special feature of the present invention is that the above-described inventive concept can be implemented or realized especially in combination with protective outerwear, especially protective workwear, preferentially personal protective equipment (PPE), existing or customary in the relevant area (e.g. in the case of firefighters especially in combination with firefighter protective outerwear according to DIN EN 469). Especially, the concept according to the invention is compatible and/or complementary with respect to existing or customary protective outerwear in the relevant area, especially protective workwear, preferentially personal protective equipment (PPE); consequently, the concept according to the invention can be implemented or realized in a particularly efficient and economical manner, especially for subsequent additional or supplementary protective equipment, especially against PAH contamination. In this case, the protective clothing used according to the invention or the protective material used according to the invention is especially used or configured as a protective undergarment (protective underwear).

Especially, the inventive concept thus also enables subsequent and/or complementary equipment in relation to an existing or customary protective outerwear in the area concerned, especially protective workwear, preferentially personal protective equipment (PPE), such as, for example, especially in the case of firefighters in combination with an existing or customary firefighter protective clothing according to DIN EN 469. In this way, existing or customary protective concepts in the relevant area can be completed or subsequently supplemented or equipped (retrofitted) with the concept according to the invention, especially with the aim of additional and/or complementary PAH protection (wherein—as already explained above—in this case the protective clothing or protective material used according to the invention is used or configured especially as protective undergarment (protective underwear)).

Furthermore, the concept according to the invention causes no or no significant (additional) stress (such as thermal stress, lack of wearing comfort, restriction of freedom of movement, etc.) for the person to be protected. This is because the inventive concept ensures a high level of wearing comfort while at the same time providing excellent protection against PAHs (i.e. PAHs in gaseous as well as in particulate form). Especially in the case of using the protective clothing or protective material used according to the invention as protective undergarment (protective underwear), it is easily possible to replace commercially available existing underwear used in the prior art (e.g. commercially available two-layer existing underwear with an outer wool layer and an inner viscose layer) with the concept according to the invention.

Tests of the concept according to the invention in practice or under real conditions (specifically: use of the protective clothing or protective material used according to the invention as protective undergarment or protective underwear in combination with conventional standard firefighter protective outerwear according to DIN EN 469 in the event of fire or for protection against PAHs in flue gases) have shown that—in direct comparison with a combination of standard commercial underwear (=standard commercial two-layer existing underwear with outer wool layer and inner viscose layer) with the same firefighter protective outerwear according to DIN EN 469—a more than 200-fold higher protective effect against PAHs can be achieved. Especially with the aforementioned combination of standard protective outerwear according to DIN EN 469 on the one hand and protective clothing or protective material used according to the invention on the other hand, a so-called protection factor with regard to PAH of significantly more than 3,000 can be achieved, whereas this protection factor in the case of a combination of the same protective outerwear together with commercially available underwear is only about 15. The so-called protection factor in relation to PAH represents the reciprocal value of the penetration in relation to PAH, i.e. if, for example, the protection factor is 100, this means that no more than 1/100 (=one hundredth) of the PAH contaminants penetrate the material; a protection factor of 100 therefore means a penetration or breakthrough of only 1% of the PAH contaminants.

The significantly increased PAH protective effect as a result of the use of the protective clothing or protective material used according to the invention —compared to a conventional protective combination of the aforementioned type—remains completely surprisingly at least essentially intact even after several corresponding fire applications under the influence of PAH and even after multiple washes of the protective clothing or protective material used according to the invention.

Further tests have also shown that the desired high-performance protective effect against contamination and penetration of PAHs in both gaseous and particulate form can only be achieved by using all the individual components or individual constituents of the protective clothing or protective material used in accordance with the invention listed above (in their specific and targeted combination and sequence), i.e. if the structure is changed, especially if individual components or individual constituents are changed or omitted, and/or if their sequence is changed, the high-performance capability described above with regard to the protective effect against PAHs in both gaseous and particulate-bound form cannot be achieved.

By specifically selecting the adsorber particles of the adsorption layer, the performance or protective performance against PAHs in the protective clothing used according to the invention or in the protective material used according to the invention can be further increased or tailored. Particularly good results are achieved with activated carbon particles, especially with particulate activated carbon, preferentially granular or spherical activated carbon, as described in detail below. This achieves a particularly high adsorption capacity in relation to the PAHs to be rendered harmless, so that particularly good performance is achieved.

Due to the high protective performance against PAHs on the one hand and due to the resistance of the materials used in the protective clothing or the protective material used according to the invention on the other hand, there is also a particularly high durability and resistance, especially wear and/or abrasion resistance, so that the concept according to the invention is highly economical and efficient.

Since the protective clothing or protective material used according to the invention can be easily decontaminated and regenerated after use, especially by washing, without reducing the protective performance against PAHs to any significant extent, the concept according to the invention can be easily implemented at low cost and can also be easily retrofitted to standard existing protective equipment. This also ensures a high degree of sustainability.

The overall result with respect to the present invention is thus a highly efficient as well as extremely economical and, moreover, also highly sustainable concept for achieving a high-performance protective function against polycyclic aromatic hydrocarbons both in gaseous and in particulate bound form, so that the present invention can provide highly effective protection of persons against exposure to and/or contamination with polycyclic aromatic hydrocarbons released from a contamination source when staying and/or working in locations in which PAHs are released or present, or a highly effective protection against exposure of persons exposed to PAHs against PAH contamination, especially for preventing or minimizing PAH contamination, respectively, wherein it is of particular advantage that the inventive concept can be implemented or realized, if necessary, in combination with protective outerwear, especially protective workwear, preferentially personal protective equipment (PPE), existing or customary in the area concerned.

The result is a highly efficient and powerful, extremely economical and also highly sustainable protection concept against polycyclic aromatic hydrocarbons in gaseous and particulate form to protect people against PAH contamination

In the following, the present invention will be described with reference to drawings or figures illustrating preferable embodiments or examples, wherein the relevant explanations apply to all aspects according to the invention and wherein the corresponding preferred embodiments are in no way limiting.

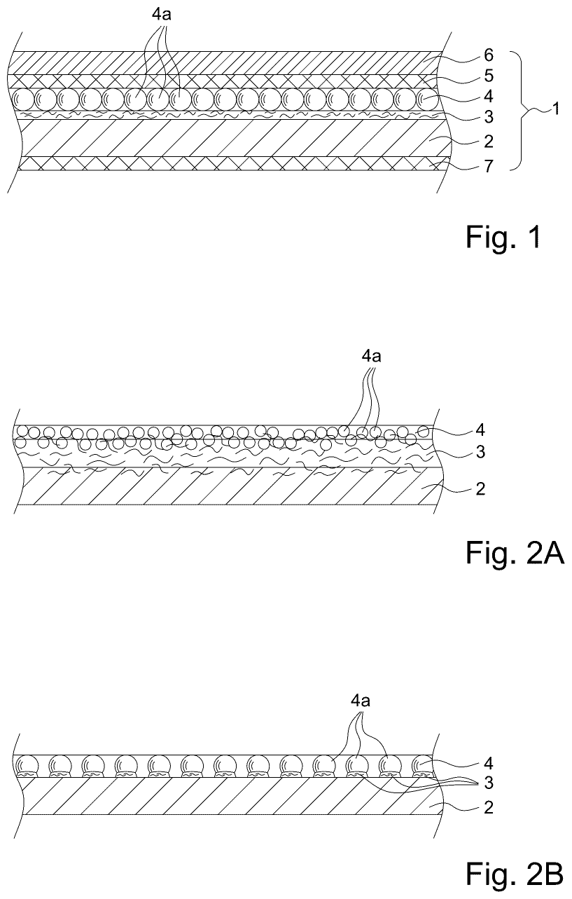

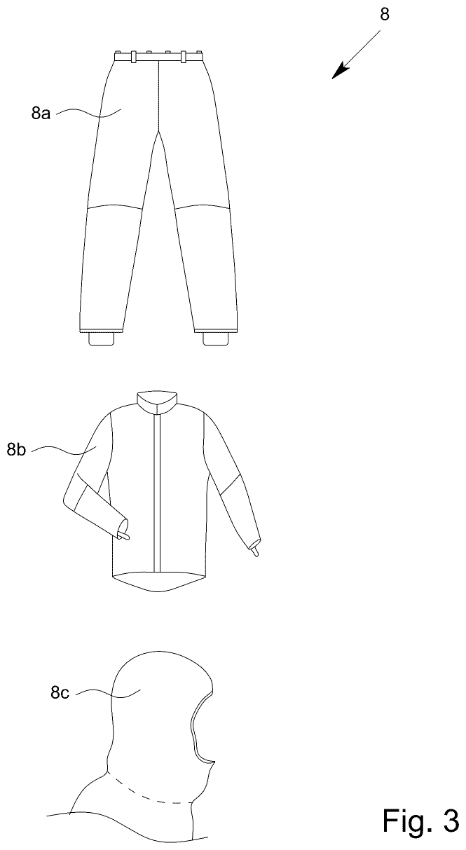

The figure illustrations relating to the present invention, i.e. the aforementioned FIG. 1, FIGS. 2A and 2B and FIG. 3, thereby illustrate and clarify the inventive concept by means of preferable embodiments or examples, as shown and described in a non-limiting manner in the aforementioned drawings or figure illustrations.

As described above, FIG. 1 shows a cross-sectional view of a protective clothing 8 used according to the invention or a protective material 1 used according to the invention in accordance with a particular embodiment of the invention, wherein the protective clothing 8 or the protective material 1 in the sequence shown in FIG. 1 has a textile support layer 2, an adhesive layer 3, an adsorption layer 4 with a plurality of individual adsorber particles 4a, a particle and/or aerosol filter layer 5, an optional cover layer 6 and an also optional further or second cover layer 7. The nature and further properties of the protective clothing 8 or protective material 1 used according to the invention and of the individual layers 2, 3, 4, 5, 6 and 7 are described in detail below in connection with the various aspects of the invention.

As FIG. 1 shows, the textile protective material 1 is configured as a multi-layered textile composite material comprising a plurality of interconnected layers 2, 3, 4, 5, 6 and 7. The individual layers 2, 3, 4, 5, 6 and 7 are preferably laminated or joined together by means of lamination.

As also previously explained, FIG. 2A shows a partial cross-sectional view of a protective clothing 8 or a textile protective material 1 used in accordance with the invention (namely only to the extent of textile support layer 2, adhesive layer 3 and adsorbent layer 4 with a plurality of individual adsorber particles 4a) according to a first and alternative to FIG. 2B embodiment of the invention, according to which the adhesive layer 3 and/or the adhesive of the adhesive layer 3 is applied to and/or provided onto the textile support layer 2 as a water vapor-permeable and/or air-permeable, preferentially water vapor- and air-permeable, and/or discontinuously formed adhesive layer based on a dried and/or cured, especially crosslinked, broken adhesive polymer foam. Further details of this first particular and alternative to FIG. 2B embodiment, especially with regard to the nature and further properties of the support layer 2, the adhesive layer 3 and the adsorbent layer 4 as well as the adsorbent particles 4a, will be described in detail below in connection with the various aspects of the invention.

As also explained above, FIG. 2B shows a partial cross-sectional view of a protective clothing 8 or a textile protective material 1 used according to the invention (namely only to the extent of textile support layer 2, adhesive layer 3 and adsorbent layer 4 with a plurality of individual adsorber particles 4a) according to a second special and alternative to FIG. 2A embodiment of the invention, wherein the adhesive layer 3 and/or the adhesive of the adhesive layer 3 is applied to and/or provided onto the textile support layer 2 as a water vapor and/or air permeable, preferentially water vapor and air permeable, and/or discontinuously formed adhesive layer in the form of a grid of a plurality of individual (i.e. non-contiguous or non-bonded) adhesive (polymer) dots distributed over the support layer 2. Further details of this second particular and alternative to FIG. 2A embodiment, especially with regard to the nature and further properties of the support layer 2, the adhesive layer 3 and the adsorbent layer 4 as well as the adsorbent particles 4a, will be described in detail below in connection with the various aspects of the invention.

Finally, FIG. 3 shows a schematic representation of a protective clothing 8 used in accordance with an embodiment of the invention, wherein the protective clothing 8 is present and/or configured as a protective leg garment 8a, especially protective trousers, and/or as a protective top garment 8b, especially a protective shirt, protective T-shirt or protective sweater, especially including covering of the arms, and/or as a protective headwear 8c, especially a protective head cover or protective balaclava. It is more preferably the case that the protective clothing 8 is present and/or configured as a combination of (i) protective leg garment 8a, especially protective trousers, (ii) protective top garment 8b, especially protective shirt, protective T-shirt or protective sweater, especially including covering of the arms, and (iii) protective headwear 8c, especially protective head cover or protective balaclava; this achieves a particularly optimized protective effect. Further details, especially with regard to the nature and further properties of the protective clothing 8 used according to the invention or the protective material 1 used according to the invention and the individual layers 2, 3, 4, 5, 6 and 7, will be described in detail below in connection with the various aspects of the invention.

In the following, the concept according to the various aspects of the invention is explained in further detail.

As previously stated (and as equally illustrated in the figure illustrations according to FIGS. 1, 2A, 2B and 3), an object of the present invention—according to a first aspect of the present invention—is the use of a protective clothing 8 (i.e. textile protective clothing), preferably in the form of a protective undergarment (protective underwear), for protecting persons against exposure to and/or contamination with polycyclic aromatic hydrocarbons (PAHs) released from a source of contamination when staying and/or working in locations in which polycyclic aromatic hydrocarbons are released or present, and/or for protecting persons exposed to polycyclic aromatic hydrocarbons against contamination (“PAH contamination”), especially to prevent or minimize contamination (“PAH contamination”),
wherein the protective clothing 8 comprises or is formed from a textile protective material 1,
wherein the textile protective material 1 is configured as a multi-layered textile composite material comprising a plurality of interconnected layers 2, 3, 4, 5, 6,
wherein the textile protective material 1 comprises the following layers 2, 3, 4, 5, 6, preferably in the sequence mentioned below:
(a) a textile support layer 2, wherein the textile support layer 2 is present and/or configured as a preferably gas-permeable textile sheet-structure (textile fabric),
(b) an adhesive layer 3 applied to one side of the textile support layer 2, wherein the adhesive layer 3 is present and/or configured as a water-vapor-permeable and/or gas-permeable and/or discontinuously formed adhesive layer, preferentially based on an adhesive polymer,
(c) an adsorption layer 4 fixed and/or adhered to the adhesive layer 3, preferentially discontinuously formed and/or gas-permeable, wherein the adsorption layer 4 comprises or is formed from a plurality of individual adsorber particles 4a,
(d) a particle and/or aerosol filter layer 5 arranged on the adsorption layer 4 and/or connected to the adsorption layer 4, preferentially a particle and aerosol filter layer 5, wherein the particle and/or aerosol filter layer 5 is present and/or configured as a gas-permeable textile sheet-structure which comprises or is formed from a plurality of individual textile fibers,
(e) optionally a cover layer 6 arranged on the particle and aerosol filter layer 5 and/or connected to the particle and aerosol filter layer 5, wherein the cover layer 6 is present and/or configured as a preferentially gas-permeable textile sheet-structure.

The advantages and special features generally associated with the inventive concept have already been described and set out in detail at the beginning, so that reference can be made to the relevant explanations above in order to avoid unnecessary repetition.

As also explained above, according to a particular embodiment of the invention, it can also be envisaged that the textile protective material 1 also comprises the following layer 7:
(f) a further or second cover layer 7 arranged on the side of the textile support layer 2 facing away from the adhesive layer 3 and/or connected thereto, wherein the further or second cover layer 7 is present and/or configured as a preferentially gas-permeable textile sheet-structure.

In other words, according to a particular embodiment of the invention, it can thus be intended that the textile protective material 1 also comprises a further or second cover layer 7 arranged on the side of the textile support layer 2 facing away from the adhesive layer 3 and/or connected thereto, wherein the further or second cover layer 7 is present and/or configured as a preferentially gas-permeable textile sheet-structure

The optional further or second cover layer 7 is used especially for additional protection and to further increase wearing comfort and also to increase wear resistance.

According to a preferable embodiment of the present invention according to this first aspect of the invention (and as equally illustrated in the figure representations according to FIGS. 1, 2A, 2B and 3), an object of the present invention is the use of a protective clothing 8 (i.e. textile protective clothing), preferably in the form of a protective undergarment (=protective underwear), for protecting persons against exposure to and/or contamination with polycyclic aromatic hydrocarbons (PAHs) released from a source of contamination when staying and/or working in locations in which polycyclic aromatic hydrocarbons are released or present and/or for protecting persons exposed to polycyclic aromatic hydrocarbons against contamination (“PAH contamination”), especially for preventing or minimizing contamination (“PAH contamination”), especially use as previously described according to the first aspect of the invention,
wherein the protective clothing 8 comprises or is formed from a textile protective material 1,
wherein the textile protective material 1 is configured as a multi-layered textile composite material comprising a plurality of interconnected layers 2, 3, 4, 5, 6,
wherein the textile protective material 1 comprises the following layers 2, 3, 4, 5, 6, preferentially in the sequence mentioned below:
(a) a textile support layer 2, wherein the textile support layer 2 is present and/or configured as a preferentially gas-permeable textile sheet-structure,
(b) an adhesive layer 3 applied to one side of the textile support layer 2, wherein the adhesive layer 3 is present and/or configured as a water vapor-permeable and/or gas-permeable and/or discontinuously formed adhesive layer, preferentially based on an adhesive polymer,
(c) an adsorption layer 4 fixed and/or adhered to the adhesive layer 3, preferentially discontinuously formed and/or gas-permeable, wherein the adsorption layer 4 comprises or is formed from a plurality of individual adsorber particles 4a,
(d) a particle and/or aerosol filter layer 5 arranged on the adsorption layer 4 and/or connected to the adsorption layer 4, preferentially a particle and aerosol filter layer 5, wherein the particle and/or aerosol filter layer 5 is present and/or configured as a gas-permeable textile sheet-structure which comprises or is formed from a plurality of individual textile fibers,
(e) a cover layer 6 arranged on the particle and aerosol filter layer 5 and/or connected to the particle and aerosol filter layer 5, wherein the cover layer 6 is present and/or configured as a preferentially gas-permeable textile sheet-structure.

According to a particular embodiment according to the first aspect of the invention, it may be intended that the protective clothing 8 is configured and/or present in the form of at least one protective garment 8a, 8b, 8c, preferentially in the form of a plurality of especially mutually complementary protective garments 8a, 8b, 8c, preferably in the form of a protective undergarment (protective underwear).

In this regard, it may especially be provided according to the invention that the protective garment 8a, 8b, 8c is especially selected from and/or in the form of: (i) protective leg garment 8a, especially protective trousers, (ii) protective top garment 8b, especially protective shirt, protective T-shirt or protective sweater, (iii) protective headwear 8c, especially protective head cover, protective hood or protective balaclava, (iv) protective overall, protective one-piece suit or protective overall suit, (v) protective hand covering, especially protective glove, and (vi) protective foot covering, especially protective stocking, protective sock or protective footwear, as well as combinations thereof; preferably is selected from and/or is in the form of (i) protective legwear 8a, especially protective trousers, (ii) protective top garment 8b, especially protective shirt, protective T-shirt or protective sweater, especially including coverage of the arms, and (iii) protective headwear 8c, especially protective head cover, protective hood or protective balaclava, as well as combinations thereof. This can provide optimum protection against PAHs.

Furthermore, according to an inventive embodiment, it can be intended that the protective clothing 8 comprises at least one protective garment 8a, 8b, 8c, preferably a plurality of especially mutually complementary protective garments 8a, 8b, 8c, preferably in the form of a protective undergarment (protective underwear).

In this regard, it may especially be intended according to the invention that the protective garment 8a, 8b, 8c is especially selected from and/or in the form of (i) protective leg garment 8a, especially protective trousers, (ii) protective top garment 8b, especially protective shirt, protective T-shirt or protective sweater, (iii) protective headwear 8c, especially protective head cover, protective hood or protective balaclava, (iv) protective overall, protective one-piece suit or protective overall suit, (v) protective hand covering, especially protective glove, and (vi) protective foot covering, especially protective stocking, protective sock or protective footwear, as well as combinations thereof; preferably is selected from and/or is in the form of (i) protective legwear 8a, especially protective trousers, (ii) protective top garment 8b, especially protective shirt, protective T-shirt or protective sweater, especially including coverage of the arms, and (iii) protective headwear 8c, especially protective head cover, protective hood or protective balaclava, as well as combinations thereof.

Furthermore, according to a preferred embodiment of the present invention, it is envisaged that the protective clothing 8, preferably in the form of a protective undergarment (protective underwear), is present and/or configured to protect the lower body, upper body and head. Especially, it can be intended in this context that the protective clothing 8 comprises a plurality of especially mutually complementary protective garments 8a, 8b, 8c, especially selected from and/or in the form of (i) protective leg garment 8a, especially protective trousers (ii) protective top garment 8b, especially protective shirt, protective T-shirt or protective sweater, (ii) protective headwear 8c, especially a protective head cover, protective hood or protective balaclava, (iv) protective overalls, protective one-piece suit or protective overall suit, (v) protective hand covering, especially protective gloves, and (vi) protective footwear, especially protective stocking, protective sock or protective footwear, as well as combinations thereof, preferably selected from and/or in the form of (i) protective legwear 8a, especially protective trousers, (ii) protective top garment 8b, especially protective shirt, protective T-shirt or protective sweater, especially including covering of the arms, and (iii) protective headwear 8c, especially protective head cover, protective hood or protective balaclava, as well as combinations thereof.

It is preferable according to the invention that the protective clothing 8 is used and/or present in the form of a protective undergarment (protective underwear). Especially, it may be intended that the protective clothing 8 is present and/or configured as a combination of (i) protective leg garment 8a, especially protective trousers, (ii) protective top garment 8b, especially protective shirt, protective T-shirt or protective sweater, especially including covering of the arms, and (iii) protective headwear 8c, especially protective head cover or protective balaclava. In this way, a particularly good protective effect against PAHs can be achieved.

According to a particularly preferable embodiment of the invention it may be intended that the protective clothing 8 is used and/or present in the form of protective undergarment (protective underwear), wherein the protective clothing 8 is present and/or configured as a combination of (i) protective leg garment 8a, especially protective trousers, (ii) protective top garment 8b, especially protective shirt, protective shirt or protective pullover, especially including covering of the arms, and (iii) protective headwear 8c, especially protective head cover or protective balaclava. In this way, a comprehensive and particularly good protective effect against PAHs can be achieved.

In the context of the present invention, it is envisaged that the protective clothing 8 and/or the protective material 1 is/are arranged and/or used during use and/or in the use state, especially in the wearing state, in such a way that the particle and/or aerosol filter layer 5 and/or the optionally present cover layer 6 is/are facing the source of contamination and/or that the particle and/or aerosol filter layer 5 and/or the optionally present cover layer 6 is/are facing away from the wearer of the protective clothing 8 and/or that the particle and/or aerosol filter layer 5 and/or the optionally present cover layer 6 forms/form an outer layer of the protective clothing 8 and/or the protective material 1.

In other words, it is envisaged in the context of the present invention that the protective clothing 8 and/or the protective material 1 is/are arranged and/or used during use and/or in the use state, especially in the wearing state, in such a way that the textile support layer 2 and/or the optionally present further or second cover layer 7 is/are facing away from the source of contamination and/or that the textile support layer 2 and/or the optionally present further or second cover layer 7 is/are facing the wearer of the protective clothing and/or that the textile support layer 2 and/or the optionally present further or second cover layer 7 forms/form an inner layer of the protective clothing 8 and/or of the protective material 1.

As already explained above, this ensures that the released polycyclic aromatic hydrocarbons (PAHs) to be rendered harmless, which at high ambient temperatures (e.g. fire smoke) are usually present both in gaseous form and in particulate-bound form (e.g. PAH-laden soot, flue gas and dust particles), first impinge on the (optional) cover layer 6 and then on the particles and/or aerosol filter layer 5 or are brought into contact therewith, before the PAH contaminants still remaining are brought into contact with the adsorption layer 4 or the adsorber particles 4a present there, accompanied by the effect described above.

According to a particularly preferable embodiment, it is envisaged that the protective clothing 8 is used as protective undergarments (protective underwear). This allows the previously described advantages and special features of the inventive concept to be realized. This especially allows subsequent equipping in relation to existing protective outerwear in the area concerned (e.g. as a complementary addition to protective outerwear for firefighters in accordance with DIN EN 469 etc.).

As described above, it is particularly preferable according to the invention that the protective clothing 8 is used as protective undergarments (protective underwear) in combination with protective outerwear, especially in combination with protective workwear, preferably in combination with personal protective equipment. For further details in this regard, reference can also be made to the above explanations in connection with the advantages and special features according to the invention.

A further object of the present invention—according to a second aspect of the present invention—is also (as also equally illustrated in the figure representations according to FIGS. 1, 2A, 2B and 3) the use of a textile protective material 1, especially in the form of a protective clothing 8, preferably in the form of a protective undergarment (=protective underwear), for preventing or minimizing contamination with polycyclic aromatic hydrocarbons released from a contamination source (“PAH contamination”), especially for protecting persons exposed to polycyclic aromatic hydrocarbons (PAHs),
wherein the textile protective material 1 is configured as a multi-layered textile composite material comprising a plurality of interconnected layers 2, 3, 4, 5, 6,
wherein the textile protective material 1 comprises the following layers 2, 3, 4, 5, 6, preferably in the sequence mentioned below:
(a) a textile support layer 2, wherein the textile support layer 2 is present and/or configured as a preferably gas-permeable textile sheet-structure,
(b) an adhesive layer 3 applied to one side of the textile support layer 2, wherein the adhesive layer 3 is present and/or configured as a water-vapor-permeable and/or gas-permeable and/or discontinuously formed adhesive layer, preferentially based on an adhesive polymer,
(c) an adsorption layer 4 which is fixed and/or adhered to the adhesive layer 3, preferentially discontinuously formed and/or gas-permeable, wherein the adsorption layer 4 comprises or is formed from a plurality of individual adsorber particles 4a,
(d) a particle and/or aerosol filter layer 5 arranged on the adsorption layer 4 and/or connected to the adsorption layer 4, preferentially a particle and aerosol filter layer 5, wherein the particle and/or aerosol filter layer 5 is present and/or configured as a gas-permeable textile sheet-structure which comprises or is formed from a plurality of individual textile fibers,
(e) optionally a cover layer 6 arranged on the particle and aerosol filter layer 5 and/or connected to the particle and aerosol filter layer 5, wherein the cover layer 6 is present and/or configured as a preferentially gas-permeable textile sheet-structure.

In this context, it can also be intended according to the second aspect of the invention in accordance with a particular embodiment of the invention that the textile protective material 1 also comprises the following layer 7:
(f) a further or second cover layer 7 arranged on the side of the textile support layer 2 facing away from the adhesive layer 3 and/or connected thereto, wherein the further or second cover layer 7 is present and/or configured as a preferentially gas-permeable textile fabric.

In other words, it can thus also be envisaged according to the second aspect of the invention in accordance with a particular embodiment of the invention that the textile protective material 1 furthermore comprises a further or second cover layer 7 arranged on the side of the textile support layer 2 facing away from the adhesive layer 3 and/or connected thereto, wherein the further or second cover layer 7 is present and/or configured as a preferentially gas-permeable textile fabric.

The optional further or second cover layer 7 is used especially for additional protection and to further increase wearer comfort and also to increase wear resistance.

According to a preferable embodiment of the present invention according to this second aspect of the invention (as also equally illustrated in the figure illustrations according to FIGS. 1, 2A, 2B and 3), an object of the present invention is the use of a textile protective material 1, especially in the form of a protective clothing 8, preferably in the form of a protective undergarment (protective underwear), for preventing or minimizing contamination with polycyclic aromatic hydrocarbons released from a contamination source (“PAH contamination”), especially for protecting persons exposed to polycyclic aromatic hydrocarbons (PAHs), especially a use as previously described according to the second aspect of the invention,
wherein the textile protective material 1 is configured as a multi-layered textile composite material comprising a plurality of interconnected layers 2, 3, 4, 5, 6,
wherein the textile protective material 1 comprises the following layers 2, 3, 4, 5, 6, preferentially in the sequence mentioned below:
(a) a textile support layer 2, wherein the textile support layer 2 is present and/or configured as a preferably gas-permeable textile sheet-structure,
(b) an adhesive layer 3 applied to one side of the textile support layer 2, wherein the adhesive layer 3 is present and/or configured as a water-vapor-permeable and/or gas-permeable and/or discontinuously formed adhesive layer, preferentially based on an adhesive polymer,
(c) an adsorption layer 4 fixed and/or adhered to the adhesive layer 3, preferentially discontinuously formed and/or gas-permeable, wherein the adsorption layer 4 comprises or is formed from a plurality of individual adsorber particles 4a,
(d) a particle and/or aerosol filter layer 5 arranged on the adsorption layer 4 and/or connected to the adsorption layer 4, preferentially a particle and aerosol filter layer 5, wherein the particle and/or aerosol filter layer 5 is present and/or configured as a gas-permeable textile sheet-structure which comprises or is formed from a plurality of individual textile fibers,
(e) a cover layer 6 arranged on the particle and aerosol filter layer 5 and/or connected to the particle and aerosol filter layer 5, wherein the cover layer 6 is present and/or configured as a preferentially gas-permeable textile sheet-structure.

According to a particular embodiment of the invention according to the second aspect of the invention, it may be intended according to the invention that the protective material 1 is configured and/or present in the form of a protective clothing 8, especially in the form of at least one protective garment 8a, 8b, 8c, preferentially in the form of a plurality of especially mutually complementary protective garments 8a, 8b, 8c, preferably in the form of a protective undergarment (protective underwear). In this regard, it may especially be intended according to the invention that the protective clothing 8 is especially selected from and/or is present in the form of: (i) protective leg garment 8a, especially protective trousers, (ii) protective top garment 8b, especially protective shirt, protective T-shirt or protective sweater, (iii) protective headwear 8c, especially protective head cover, protective hood or protective balaclava, (iv) protective overall, protective one-piece suit or protective overall suit, (v) protective hand covering, especially protective glove, and (vi) protective foot covering, especially protective stocking, protective sock or protective footwear, as well as combinations thereof, preferably is selected from and/or is in the form of: (i) protective legwear 8a, especially protective trousers, (ii) protective top garment 8b, especially protective shirt, protective T-shirt or protective sweater, especially including coverage of the arms, and (iii) protective headwear 8c, especially protective head cover, protective hood or protective balaclava, as well as combinations thereof. This ensures a particularly high level of PAH protection.

According to a further particular embodiment of the invention according to the second aspect of the invention, it may further be intended that the protective material 1 is present and/or configured in the form of a protective clothing 8, preferably in the form of a protective undergarment (protective underwear), for protecting the lower body, upper body and head. In this respect, it can especially be intended that the protective clothing 8 comprises a plurality of especially mutually complementary protective garments 8a, 8b, 8c, especially selected from and/or in the form of: (i) protective leg garment 8a, especially protective trousers (ii) protective top garment 8b, especially protective shirt, protective T-shirt or protective sweater, (iii) protective headwear 8c, especially protective head cover, protective hood or protective balaclava, (iv) protective overall, protective one-piece suit or protective overall suit, (v) protective handwear especially protective gloves, and (vi) protective foot covering, especially protective stocking, protective sock or protective footwear, as well as combinations thereof, preferably selected from and/or in the form of (i) protective leg garment 8a, especially protective trousers, (ii) protective top garment 8b, especially protective shirt, protective T-shirt or protective sweater, especially including covering of the arms, and (iii) protective headwear 8c, especially protective head cover, protective hood or protective balaclava, as well as combinations thereof. This ensures a particularly high level of PAH protection.

Furthermore, according to a preferable embodiment according to the second aspect of the invention, it may be intended that the protective material 1 is used and/or present as a protective clothing 8 in the form of a protective undergarment (protective underwear).

Furthermore, with regard to the second aspect of the invention, it may be intended that the protective material 1 is present and/or configured as a protective clothing 8 in the form of a combination of (i) protective leg garment 8a, especially protective trousers, (ii) protective top garment 8b, especially protective shirt, protective T-shirt or protective sweater, especially including covering of the arms, and (iii) protective headwear 8c, especially protective head cover or protective balaclava.

In accordance with a preferable embodiment of the present invention according to the second aspect of the invention, it may be intended in the context of use according to the inventive invention that the protective material 1 is used and/or present as a protective clothing 8 in the form of a protective undergarment (protective underwear), wherein the protective clothing 8 is present and/or configured as a combination of (i) protective leg garment 8a, especially protective trousers, (ii) protective top garment 8b, especially protective shirt, protective T-shirt or protective sweater, especially including covering of the arms, and (iii) protective headwear 8c, especially protective head cover or protective balaclava.

With regard to the use of the protective material 1 during use or in the use state, the following is to be stated: According to the invention, it is envisaged that the protective material 1 is arranged and/or used during use and/or in the use state in such a way that the particle and/or aerosol filter layer 5 and/or the optionally present cover layer 6 is/are facing the source of contamination. In other words, it is intended according to the inventive embodiment that the protective material 1 is arranged and/or used during use and/or in the use state in such a way that the textile support layer 2 and/or the optionally present further or second cover layer 7 is/are facing away from the source of contamination.

In other words, it is envisaged in the context of the inventive use that the protective material 1 is used and/or present in the form of a protective clothing 8, preferably in the form of a protective undergarment (protective underwear), wherein the protective clothing 8 and/or the protective material 1 is/are arranged and/or used during use and/or in the use state, especially in the wearing state, in such a way that the particle and/or aerosol filter layer 5 and/or the optionally present cover layer 6 is/are facing the source of contamination and/or that the particle and/or aerosol filter layer 5 and/or the optionally present cover layer 6 is/are facing away from the wearer of the protective clothing 8 and/or that the particle and/or aerosol filter layer 5 and/or the optionally present cover layer 6 forms/forms an outer layer of the protective clothing 8 and/or the protective material 1. This is associated with the advantages and special features described above.

In the context of the present invention, the inventive use is carried out in such a way that the protective material 1 is used and/or present in the form of a protective clothing 8, preferably in the form of a protective undergarment (protective underwear), wherein the protective clothing 8 and/or the protective material 1 is/are arranged and/or used during use and/or in the use state, especially in the wearing state, in such a way that the textile support layer 2 and/or the optionally present further or second cover layer 7 is/are turned away from the source of contamination and/or that the textile support layer 2 and/or the optionally present further or second cover layer 7 is/are turned towards the wearer of the protective clothing and/or that the textile support layer 2 and/or the optionally present further or second cover layer 7 forms/forms an inner layer of the protective clothing 8 and/or the protective material 1. This is associated with the advantages and special features described above.

The following explanations of the present invention relate both to the use according to the first aspect of the invention and to the use according to the second aspect of the invention.

The area weight of the protective material 1 used according to the invention and/or the protective clothing 8 used according to the invention can vary over a wide range. Typically, it is envisaged in the context of the present invention that the protective material 1 and/or the protective clothing 8 has a total area weight (especially determined as dry weight) in the range of from 200 g/m² to 1.000 g/m², especially in the range of from 225 g/m² to 750 g/m², preferentially in the range of from 250 g/m² to 650 g/m², more preferably in the range of from 275 g/m² to 600 g/m², even more preferably in the range of from 300 g/m² to 450 g/m², especially determined in accordance with DIN EN 12127, preferentially after drying at 105 °C for 1 hour. This ensures, at the same time, good wearing comfort and excellent PAH protection performance.

Regarding the protective material 1 used according to the invention or the protective clothing 8 used according to the invention, it can also be configured to be non-elastic or at least partially elastic. It is especially preferable if the protective material 1 used according to the invention or the protective clothing 8 used according to the invention is configured to be at least partially elastic, especially wherein the protective material 1 used according to the invention or the protective clothing 8 used according to the invention is configured to be elastic at least in the areas in which it is exposed to mechanical stress, especially bending, tensile and/or stretching stress (bending, tensile and/or stretching strain), in the state of use and/or wear (e.g. in the area of the knees, arm bends, armpits, groin, etc.).

As already explained above, it is envisaged and preferable according to the invention that the protective material 1 and/or the protective clothing 8 is configured to be gas-permeable, especially air-permeable, and/or water-vapor-permeable, preferentially gas-permeable, especially air-permeable, and water-vapor-permeable. In this way, particularly good wearer comfort is achieved without impairing the excellent PAH protective performance.

The gas permeability, especially air permeability, of the protective material 1 used according to the invention or of the protective clothing 8 used according to the invention can vary over a wide range. Especially, the protective material 1 and/or the protective clothing 8 can have a gas permeability, especially air permeability, at a flow resistance of 100 Pascal, especially determined in accordance with DIN EN ISO 9237, of at least 0.5 mm/s, especially of at least 1 mm/s, preferentially of at least 2.5 mm/s more preferably of at least 3.5 mm/s, even more preferably of at least 5 mm/s. It is preferable that the protective material 1 and/or the protective clothing 8 have a gas permeability, especially air permeability, at a flow resistance of 100 Pascal, especially determined in accordance with DIN EN ISO 9237, of up to 500 mm/s. Furthermore, it is preferred that the protective material 1 and/or the protective clothing 8 has a gas permeability, especially air permeability, at a flow resistance of 100 Pascal, especially determined in accordance with DIN EN ISO 9237, in the range of from 0.5 mm/s to 500 mm/s, especially in the range of from 1 mm/s to 450 mm/s, preferentially in the range of from 2.5 mm/s to 400 mm/s, more preferably in the range of from 3.5 mm/s to 300 mm/s, even more preferably in the range of from 5 mm/s to 250 mm/s. This results in particularly good wearing comfort combined with excellent PAH protection performance.

The water vapor transmission resistance (Rₑₜ) can also vary over a wide range: In this context, it is preferred that the protective material 1 and/or the protective clothing 8 has a water vapor transmission resistance (Rₑₜ), especially determined in accordance with DIN EN 343:2019, of at most 15 m² Pa/Watt, especially of at most 10 m² Pa/Watt, preferably of at most 8 m² Pa/Watt, preferentially of at most 7 m² Pa/Watt, even more preferably of at most 6 m² Pa/Watt, further preferably of at most 5 m² Pa/Watt. It is particularly preferable that the protective material 1 and/or the protective clothing 8 has a water vapor transmission resistance (Rₑₜ) according to class 4 of DIN EN 343:2019, especially a Rₑₜ≤15 m² Pa/Watt. In this way, a high level of wearing comfort is ensured or made possible while at the same time providing good protection.

The thickness, especially the overall cross-sectional thickness, of the protective material 1 used according to the invention or the protective clothing 8 used according to the invention can also vary over a wide range: Especially, it is envisaged in the context of the present invention that the protective material 1 and/or the protective clothing 8 has a thickness, especially an overall cross-sectional thickness, in the range of from 0.25 mm to 25 mm, especially in the range of from 0.5 mm to 15 mm, preferably in the range of from 0.6 mm to 10 mm, preferentially in the range of from 0.75 mm to 5 mm, more preferably in the range of from 0.8 mm to 2 mm, especially determined in accordance with DIN EN ISO 5084. This ensures that, on the one hand, sufficient PAH protection is provided and, on the other hand, good wearing comfort is ensured.

For good wear resistance of the protective material 1 or the protective clothing 8 used in accordance with the invention, it is also advantageous that the protective material 1 or the protective clothing 8 used has a defined burst pressure and a defined elongation load or elongation capacity (emulation) and also a defined shrinkage.

In this context, it is especially preferable according to the invention that the protective material 1 and/or the protective clothing 8 has a burst pressure, especially determined in accordance with DIN EN ISO 13938-2, of at least 50 kPa (kilopascals), especially of at least 75 kPa, preferentially of at least 90 kPa, more preferably of at least 100 kPa.

Preferably, the protective material 1 and/or the protective clothing 8 has a burst pressure, especially determined in accordance with DIN EN ISO 13938-2, in the range of from 50 kPa (kilopascals) to 1,000 kPa, especially in the range of from 75 kPa to 800 kPa, preferentially in the range of from 90 kPa to 600 kPa, more preferably in the range of from 100 kPa to 500 kPa. As explained above, this ensures a high resistance to wear.

Furthermore, in this context it is especially preferable according to the invention that the protective material 1 and/or the protective clothing 8 has a maximum tensile force and/or maximum tensile elongation, preferably in the longitudinal and transverse direction, especially determined in accordance with DIN EN ISO 13934-1, of at least 200 Newtons, especially of at least 225 Newtons, preferentially of at least 250 Newtons, more preferably of at least 275 Newtons.

Preferably, the protective material 1 and/or the protective clothing 8 has a maximum tensile force and/or maximum tensile elongation, preferably in the longitudinal and transverse direction, especially determined in accordance with DIN EN ISO 13934-1, in the range of from 200 Newtons to 4,000 Newtons, especially in the range of from 225 Newtons to 3,750 Newtons, preferentially in the range of from 250 Newtons to 3,500 Newtons, more preferably in the range of from 275 Newtons to 3,000 Newtons.

Furthermore, it is preferable according to the invention that the protective material 1 and/or the protective clothing 8 has an elongation load and/or elongation capacity (elongation) in longitudinal and transverse direction, determined in accordance with DIN 53835-14 at 20 Newton, of at least 2.5%, preferentially of at least 5%. It is especially preferable that the protective material 1 and/or the protective clothing 8 has an elongation load and/or elongation capacity (elongation) in at least one direction, especially in the longitudinal or transverse direction, determined in accordance with DIN 53835-14 at 20 Newton, of at least 2.5%, preferentially of at least 5%, preferably of at least 10%. As explained above, this ensures a high level of wear resistance.

Furthermore, it is preferably according to the invention that the protective material 1 and/or the protective clothing 8 has a shrinkage in the longitudinal and transverse direction, determined in accordance with DIN EN 5077, of at most 10%, preferentially of at most 6%. In this context, it is particularly preferable that the protective material 1 and/or the protective clothing 8 has a shrinkage in at least one direction, especially in the longitudinal or transverse direction, determined in accordance with DIN EN 5077, of at most 10%, preferentially of at most 6%, preferably of at most 3%. In this way, in addition to good wear resistance, it is also ensured that the protective material 1 or the protective clothing 8 used according to the invention is also resistant to regeneration treatment, especially by means of washing.

As already explained at the beginning, it is envisaged in accordance with the invention that the protective material 1 and/or the protective clothing 8 is configured to be washable, especially washable and dryable. This enables good regenerability and thus multiple use, so that the cost economy and sustainability are significantly increased as a result.

With regard to the protective effect against particulate-bound PAH contamination, further performance properties of the protective material 1 or the protective clothing 8 used in accordance with the invention are important, especially the average efficiency Eₘ according to DIN EN 779 (July 1993), the integral initial permeability Dᵢ according to DIN EN 1822 (April 1998; DEHS aerosol, MPPS=0.1 to 0.3 μm) and the average deposition rate with respect to particles and/or aerosols. These properties or parameters are significantly adjusted and tailored via the aerosol and/or particle filter layer 5 provided in accordance with the invention and also at least partially by the optionally provided cover layer 6.

In this context, it is preferable for good PAH protection performance that the protective material 1 and/or the protective clothing 8 has an average efficiency Eₘ according to DIN EN 779 (July 1993) of at least 40%, especially at least 50%, preferentially at least 70%, more preferably at least 90%, even more preferably at least 95%, and/or that the protective material 1 has an average separation efficiency Aₘ according to DIN EN 779 (July 1993) of at least 50%, especially at least 70%, preferentially at least 90%, more preferably at least 95%, even more preferably at least 99%.

Furthermore, in order to ensure good PAH protection, especially against particulate-bound PAHs, it is preferable that the protective material 1 and/or the protective clothing 8 has an integral initial permeability Dᵢ according to DIN EN 1822 (April 1998; DEHS aerosol, MPPS=0.1 to 0.3 μm) of at most 50%, especially at most 40%, preferentially at most 30%, more preferably at most 20%, even more preferably at most 10%.

In addition, with regard to good PAH protection performance, especially against particulate-bound PAH, it is advantageous that the protective material 1 and/or the protective clothing 8 has an average deposition rate with respect to particles and/or aerosols with diameters in the range of from 0.1 to 0.3 μm at an incident flow velocity of 0.1 m/s of at least 80%, especially at least 90%, preferentially at least 95%, and/or that the protective material 1 has an average separation rate with respect to particles and/or aerosols with diameters ≥2 μm, especially ≥1.5 μm, preferably ≥1.0 μm, at an incident flow velocity of 0.1 m/s of at least 95%, especially at least 98%, preferably at least 99%.

The MPPS (Most Penetrating Particle Size) evaluation criterion refers to the particle size at which a filter material (here: protective material 1 or protective clothing 8) has its lowest separation efficiency.

Furthermore, with regard to good PAH protection performance, especially against particulate-bound PAHs, it is advantageous that the protective material 1 and/or the protective clothing 8 has a separation efficiency, especially a fractional separation efficiency, of at least 80%, especially at least 85%, preferentially at least 90%, determined in accordance with DIN EN 1822 at a pressure difference of 15 Pascals with potassium chloride (KCl) as the test substance as the minimum efficiency (MPPS, especially MPPS=0.1 μm to 0.3 μm).

Furthermore, with regard to good PAH protection performance, especially against gaseous PAHs, it is advantageous that the protective material 1 and/or the protective clothing 8 has a butane adsorption, determined in accordance with ASTM D5742-16, of at least 10 g/m², especially of at least 15 g/m², preferentially of at least 20 g/m². The butane adsorption capacity is largely due to the adsorption layer 4 or the adsorber particles 4a, preferentially activated carbon, and is especially a measure of the micropore volume of the adsorption layer 4 or the adsorber particles 4a. In this way, a particularly good adsorption performance with regard to PAHs is achieved. With regard to the butane adsorption capacity of activated carbon, reference can also be made to the following explanations.

The above-mentioned properties, especially physicochemical and mechanical parameters, of the protective material 1 used according to the invention or of the protective clothing 8 used according to the invention can be adjusted or controlled in a targeted or customized manner by the selection and composition of the individual layers 2, 3, 4, 5, 6 and 7, especially the material selection and composition of the individual layers 2, 3, 4, 5, 6 and 7. Realizing this in a specific individual case is known and familiar to the skilled person working in this field as such, so that he can fall back on his general expertise in this respect and so that no further explanations are required in this respect. Nevertheless, further specific and detailed explanations can be found below, especially with regard to the choice of material and composition as well as combinations of the individual layers 2, 3, 4, 5, 6 and 7.

Further details of the properties of the individual layers 2, 3, 4, 5, 6 and 7 of the protective material 1 used in accordance with the invention or of the protective clothing 8 used in accordance with the invention are set out below:

As far as the textile support layer 2 of the protective material 1 used in accordance with the invention is concerned, the textile support layer 2 is usually configured as an air-permeable textile sheet-structure.

Preferably, the textile support layer 2 is configured as an air-permeable textile sheet-structure, preferably as a knitwear, especially as a crotched fabric or knitted fabric.

It is further preferred that the textile support layer 2 comprises or is formed from natural fibers and/or synthetic fibers (man-made fibers), preferably natural fibers, more preferably cotton fibers.

It is particularly preferably that the textile support layer 2 comprises or is formed from natural fibers, more preferably cotton fibers, optionally in combination with synthetic fibers (man-made fibers).

According to a particular embodiment of the present invention, it is envisaged that the textile support layer 2 has an area weight (especially determined as dry weight) in the range of from 10 g/m² to 275 g/m², especially in the range of from 15 g/m² to 175 g/m², preferentially in the range of from 25 g/m² to 150 g/m², more preferably in the range of from 30 g/m² to 100 g/m², especially determined in accordance with DIN EN 12127, preferentially after drying at 105 °C for 1 hour.

The previously configured textile support layer 2 ensures particularly good wearing comfort and good wear properties of the material.

Especially by configuring the textile support layer 2 as a knitwear, especially as crocheted fabric or knitted fabric, preferably based on natural fibers (more preferably cotton fibers), optionally in combination with synthetic fibers (man-made fibers), good stretch and tear resistance are achieved in addition to wearing comfort and good wear properties.

Suitable materials according to the invention with the aforementioned properties for the formation of a textile support layer 2 as described above are known and familiar as such to the skilled person working in this field.

Regarding the adhesive layer 3 of the protective material 1 used according to the invention, the following should be stated in this respect:

The quantity of the application of the adhesive layer 3 and/or the adhesive of the adhesive layer 3 can vary over a wide range. In general, the adhesive layer 3 and/or the adhesive of the adhesive layer 3 is applied to and/or provided onto the textile support layer 2 in an application quantity in the range of from 5 g/m² to 80 g/m², especially in the range of from 10 g/m² to 60 g/m², preferentially in the range of from 15 g/m² to 50 g/m². In this way, a good fixation of the adsorption layer 4 with a simultaneously low weight per unit area and thus good wearing comfort as well as good water vapor permeability is ensured.

The material of the adhesive or adhesive polymer can also vary over a wide range. It may especially be envisaged that the adhesive and/or the adhesive polymer is selected from the group of polyacrylates (PA), polymethacrylates (PMA), polymethyl methacrylates (PMMA), polycarbonates (PC), polyurethanes (PU) and silicones as well as mixtures or combinations of at least two of the aforementioned compounds, preferentially polyurethane (PU). The aforementioned adhesives or adhesive polymers ensure excellent fixation of the adsorption layer 4 while at the same time providing good wearing comfort, especially good water vapor permeability.

It is particularly preferable that the adhesive and/or the adhesive polymer is a polyurethane (PU). On the one hand, this leads to particularly good bonding results with respect to the adsorption layer 4 and, due to the good water vapor permeability of polyurethanes, ensures excellent wearing comfort. The adsorption performance of the adsorber particles 4a is also least impaired by the polyurethane when the surface of the adsorber particles 4a is wetted.

The density of the adhesive layer 3 can also vary over a wide range. In general, it is preferable for the adhesive layer 3 to have a density in the range of from 100 g/l to 500 g/l, especially in the range of from 150 g/l to 400 g/l, preferentially in the range of from 200 g/l to 350 g/l. This ensures a low weight per unit area and therefore good overall wearing comfort of the protective material 1 or protective clothing 8.

According to a particular embodiment of the present invention, it may be intended that the adhesive layer 3 is partially penetrated into the textile support layer 2 and/or wherein the adhesive layer 3 extends into the textile support layer 2. This enables a particularly secure fixation between the textile support 2, adhesive layer 3 and adsorption layer 4. In addition, the thickness of the adhesive layer 3 is reduced in cross-section in this way, which leads to a lower overall thickness of the protective material 1 or the protective clothing 8, accompanied with good wearing comfort.

In general, in the context of the inventive uses, it is envisaged that the adhesive layer 3 and/or the adhesive of the adhesive layer 3 is applied to and/or provided onto the textile support layer 2 as a water vapor-permeable and/or air-permeable, preferentially water vapor- and air-permeable, and/or discontinuously formed adhesive layer based on an adhesive polymer, wherein the adhesive layer is configured either in the form of a dried and/or cured, especially crosslinked, broken adhesive polymer foam or in the form of a grid of a plurality of adhesive (polymer) dots distributed over the support layer 2, preferentially in the form of a dried and/or cured, especially crosslinked, broken adhesive polymer foam.

In this regard, it may be intended according to the inventive invention that the adhesive layer is configured either in the form of a dried and/or cured, especially crosslinked, broken adhesive polymer foam or in the form of a grid of a plurality of adhesive (polymer) dots distributed over the support layer 2, preferentially in the form of a dried and/or cured, especially crosslinked, broken adhesive polymer foam.

This ensures particularly good water vapor and/or air permeability, especially water vapor and air permeability, with excellent fixing or bonding properties at the same time.

The application of the adhesive layer in the form of a dried and/or cured, especially crosslinked, broken adhesive polymer foam is more preferably in the context of bonding, as this leads to particularly low densities of the adhesive layer 3 and thus to a particularly low weight per unit area, accompanied by the associated advantages and special features (i.e. improved wearing comfort, lower overall thickness of the protective material 1 or protective clothing 8, etc.).

The formation of the adhesive layer 3 or the adhesive layer in the form of a dried and/or cured, especially crosslinked, broken adhesive polymer foam is also advantageous because the adhesive layer 3 not only ensures the fixation of the adsorption layer 4 on the textile support layer 2, but also has the function of ensuring that, in the event of gaseous PAH contamination being encountered, a sufficient residence time and/or convection of the gaseous PAH loads to be adsorbed is ensured in the event of use. In the case of adhesion in the form of the adhesive polymer foam described above or in the case of configuring the adhesive layer 3 in the form of the adhesive polymer foam described above, this function of the adhesive layer 3 can be fulfilled to a particular extent.

The application of the adhesive layer 3, especially the adhesive or adhesive polymer of the adhesive layer 3, according to the two aforementioned bonding methods (i.e. either in the form of a dried and/or cured, especially crosslinked, broken adhesive polymer foam or in the form of a grid of a plurality of individual adhesive (polymer) dots distributed over the support layer 2) is sufficiently known to the skilled person as such, so that no further explanations need to be made in this regard. Reference is also made in this respect to the following description in the examples.

As previously set forth, according to one embodiment of the present invention, it may be envisaged that the adhesive layer 3 and/or the adhesive of the adhesive layer 3 is applied to and/or provided onto the textile support layer 2 as a water vapor-permeable and/or air-permeable, preferentially water vapor- and air-permeable, and/or discontinuously formed adhesive layer based on a dried and/or cured, especially crosslinked, broken adhesive polymer foam. The advantages associated with this embodiment have been described in detail above.

Especially, it can be envisaged that the broken adhesive polymer foam comprises a plurality of dried and/or cured, especially crosslinked, destroyed and/or burst and/or collapsed foam bubbles.

Furthermore, it may especially be envisaged that the broken adhesive polymer foam, especially the dried and/or cured, especially crosslinked, destroyed and/or burst and/or collapsed foam bubbles of the broken adhesive foam, comprises or comprise a plurality of destroyed and/or broken and/or collapsed walls and/or webs of adhesive polymer.

Furthermore, according to the invention, it may especially be envisaged that the broken adhesive polymer foam has a proportion of destroyed and/or burst and/or collapsed foam bubbles of at least 10%, especially at least 30%, preferentially at least 50%, preferably at least 70%, more preferably at least 90%, even more preferably at least 95%, relative to the total number of foam bubbles in the broken adhesive polymer foam.

Furthermore, in this context, it can especially be envisaged that the broken adhesive polymer foam has a proportion of destroyed and/or burst and/or collapsed foam bubbles in the range of from 10% to 100%, especially in the range of from 30% to 99.9%, preferentially in the range of from 50% to 99%, preferably in the range of from 70% to 99%, more preferably in the range of from 90% to 98%, based on the total number of foam bubbles in the broken adhesive polymer foam.

Furthermore, it may especially be envisaged that the broken adhesive polymer foam is not configured to be closed and/or especially wherein the broken adhesive polymer foam has a plurality of perforations, pores, channels and/or openings especially extending in the broken adhesive polymer foam and/or a plurality of perforations, pores, channels and/or openings especially connecting the respective outer sides of the broken adhesive polymer foam and/or the adhesive layer.

It is especially preferable according to the invention that the broken adhesive polymer foam is configured to be contiguous and/or coherent.

Furthermore, it may especially be envisaged that the broken adhesive polymer foam is applied to and/or provided onto at least substantially the entire surface and/or the entire side of the textile support layer 2.

Especially, it can be envisaged that the broken adhesive polymer foam has a reduced density and/or volume weight by at least 5%, especially by at least 10%, preferentially by at least 15%, preferably by at least 20%, more preferably by at least 25%, compared to a corresponding non-foamed and/or continuously formed adhesive polymer, based on the non-foamed and/or continuously formed adhesive polymer.

Especially, it can further be provided that the broken adhesive polymer foam has a reduced density and/or a reduced, especially area-related reduced, volume weight, relative to the non-foamed and/or continuously formed adhesive polymer, in the range of from 5% to 80%, especially in the range of from 10% to 70%, preferably in the range of from 15% to 60%, preferably in the range of from 20% to 55%, compared to a corresponding non-foamed and/or continuously formed adhesive polymer.

Especially, it can furthermore be envisaged that the broken adhesive polymer foam, compared to a corresponding intact and/or unbroken adhesive polymer foam, has an increased density and/or volume weight by at most 10%, especially at most 5%, preferentially at most 1%, based on the intact and/or unbroken adhesive polymer foam.

Furthermore, it can especially be provided that the broken adhesive polymer foam has an elasticity and/or reversible extensibility, compared to a corresponding intact and/or unbroken adhesive polymer foam, reduced by at most 30%, especially by at most 20%, preferentially by at most 10%, preferably by at most 5%, relative to the intact and/or unbroken adhesive polymer foam.

In addition, it can especially be envisaged that the broken adhesive polymer foam has a reduced elasticity and/or reversible extensibility, compared to a corresponding intact and/or unbroken adhesive polymer foam, in the range of from 5% to 30%, especially in the range of from 10% to 20%, relative to the intact and/or unbroken adhesive polymer foam.

Finally, in this embodiment it may especially also be envisaged that the broken adhesive polymer foam is obtainable by drying and/or curing, especially crosslinking, of a foamed, preferentially foamed under mechanical energy input, aqueous or organic-based, preferentially aqueous, solution and/or dispersion of the adhesive polymer, especially accompanied by at least partial refraction of the foam provided by the foamed solution and/or dispersion of the adhesive polymer, especially wherein the drying and/or curing, especially crosslinking, is performed in the presence of at least one foaming agent and optionally at least one foam stabilizer and optionally at least one crosslinking agent and optionally at least one emulsifier and optionally at least one thickener.

For further details in this regard in relation to this particular form of application of the adhesive layer 3, especially the application of the adhesive or adhesive polymer, reference can also be made especially to the international publication WO 2017/016694 A1, the entire disclosure content of which is hereby incorporated by reference.

According to an alternative embodiment of the invention, however, it may also be envisaged that the adhesive layer 3 and/or the adhesive of the adhesive layer 3 is applied to and/or provided onto the textile support layer 2 as a water vapor-permeable and/or air-permeable, preferentially water vapor- and air-permeable, and/or discontinuously formed adhesive layer based on an adhesive polymer, wherein the adhesive layer is configured in the form of a grid of a plurality of adhesive (polymer) dots distributed over the support layer 2; and/or wherein the adhesive layer is configured in the form of a grid of a plurality of adhesive (polymer) dots distributed over the support layer.

In this context, it is especially envisaged that the adhesive layer covers at most 75% of the surface of the support layer 2, preferentially at most 60% of the surface of the support layer 2, more preferably at most 50% of the surface of the support layer 2, even more preferentially at most 40% of the surface of the support layer 2. This ensures good wearing comfort, especially high water-vapor and air permeability, with excellent fixation or adhesion and excellent PAH protective performance properties.

It can especially be envisaged according to the invention that the grid of the plurality of adhesive (polymer) dots distributed over the support layer 2 is configured regularly or irregularly.

Furthermore, it is especially envisaged that the adhesive (polymer) dots have at least substantially the same size, especially size expansion.

Performing the application of the adhesive layer 3, especially the adhesive or adhesive polymer, according to this embodiment is also sufficiently known to the person skilled in the art. For this purpose, for example, the adhesive polymer can be applied to the textile support 2 in the form of an adhesive polymer dispersion or in the form of a hot-melt adhesive polymer, for example by means of a stencil, followed by a subsequent application of the adsorber particles 4a of the adsorption layer 4 with subsequent crosslinking and curing of the adhesive or adhesive polymer. For details in this regard, reference can also be made to the following embodiments.

Suitable materials according to the invention with the aforementioned properties for the formation of an adhesive layer 3 as described above are known and familiar as such to the skilled person working in this field, so that no further explanations are required in this regard. This also applies to the manner and quantities of application, etc. and with regard to further details of the formation of the adhesive layer 3.

Regarding the adsorption layer 4 and the adsorber particles 4a present there of the protective material 1 used according to the invention, the following should be stated in this respect:

The material of the adsorber particles 4a of the adsorption layer 4 can vary over a wide range. It may especially be envisaged, in accordance with the invention, that the adsorbent particles 4a of the adsorption layer 4 are selected from the group consisting of
(i) especially particulate activated carbon and/or activated carbon particles, preferentially in the form of activated carbon particles in granular form (“granular carbon”) or activated carbon particles in spherical form (“spherical carbon”) or activated carbon particles in fibrous form (“fibrous carbon”);
(ii) zeolites, especially natural and/or synthetic zeolites;
(iii) molecular sieves, especially zeolitic molecular sieves, synthetic molecular sieves and/or especially synthetic molecular sieves based on carbon, oxides and/or glasses;
(iv) metal oxide and/or metal particles;
(v) ion exchange resins, especially polydisperse and/or monodisperse cation and/or anion exchangers, especially of the gel type and/or macroporous type;
(vi) inorganic oxides, especially silicon dioxides, silica gels and/or aluminum oxides;
(vii) porous organic polymers and/or porous organic-inorganic hybrid polymers and/or metal-organic framework materials, especially MOFs (Metal Organic Framework), COFs (Covalent Organic Framework), ZIFs (Zeolite Imidazolate Framework), POMs (Polymer Organic Material) and/or OFCs;
(viii) mineral granulates;
(ix) clathrates; and
(x) their mixtures and/or combinations;
   wherein (i) is more preferably.

In the context of the present invention, it is especially preferable that the adsorber particles 4a of the adsorption layer 4 are activated carbon particles, preferentially in the form of activated carbon particles in granular form (“granular carbon”) or activated carbon particles in spherical form (“spherical carbon”), preferably in the form of activated carbon particles in spherical form. In this way, particularly good protection against PAHs is achieved.

Suitable adsorbers or adsorber particles 4a according to the invention, especially in the form of activated carbons as described below, are commercially obtainable or commercially available, for example from Blücher GmbH, Erkrath/Germany, or other commercial manufacturers and suppliers of activated carbon.

Adsorbers or adsorber particles 4a, especially in the form of activated carbons, which can be used more preferably according to the invention, with the properties and parameters mentioned below are described especially in the following prior art documents: DE 20 2006 016 898 U1, EP 1 918 022 and US 2008/0107589 A1, WO 01/83688 (PCT/EP 01/04615), WO 2011/003434 (PCT/EP 2009/007172), WO 2008/110233 (PCT/EP 2008/000606) and WO 2013/068060 (PCT/EP 2012/003743).

The size of the adsorber particles 4a can also vary over a wide range. Especially, it is envisaged according to the invention that the diameter of the adsorber particles 4a, especially of the activated carbon particles, is 0.005 mm to 2.5 mm, preferentially 0.01 mm to 2 mm, preferably 0.015 mm to 1.5 mm, more preferably 0.02 mm to 1.25 mm, even more preferably 0.03 mm to 1 mm, and/or that the mean diameter, especially the mean diameter D₅₀, of the adsorber particles 4a, especially the activated carbon particles, is 0.01 mm to 2 mm, especially 0.02 mm to 1.75 mm, preferably 0.03 mm to 1.5 mm, more preferably 0.04 mm to 1.25 mm, even more preferably 0.04 mm to 1 mm. In this way, a good adsorption capacity and loadability with PAHs is ensured with simultaneously acceptable layer thicknesses.

The quantity in which the adsorber particles 4a are present or applied can also vary over a wide range. Especially, it may be provided according to the invention that the adsorber particles 4a, especially the activated carbon particles, are used in an amount in the range of from 5 g/m² to 300 g/m², especially 25 g/m² to 275 g/m², preferentially 30 g/m² to 250 g/m², preferably 50 g/m² to 200 g/m², and/or that the protective material 1, especially the adsorption layer 4, comprises the adsorber particles 4a, especially the activated carbon particles, in an amount in the range of from 5 g/m² to 300 g/m², especially 25 g/m² to 275 g/m², preferentially 30 g/m² to 250 g/m², preferably 50 g/m² to 200 g/m².

Particularly good results are obtained if the adsorber particles 4a, especially the activated carbon particles, are obtainable by carbonization and subsequent activation of a synthetic and/or non-natural substance-based particulate starting material, especially based on organic polymer particles.

Particularly good results are also obtained if the adsorber particles 4a, especially the activated carbon particles, are obtained from a particulate starting material based on organic polymers, especially based on sulfonated organic polymers, preferably based on divinylbenzene-crosslinked polystyrene, preferably based on styrene/divinylbenzene copolymers, especially by carbonization and subsequent activation of the starting material, especially wherein the content of divinylbenzene in the starting material is in the range of from 1 wt.-% to 20 wt.-%, especially 1 wt. % to 15 wt. %, preferentially 1.5 wt. % to 12.5 wt. %, preferably 2 wt. % to 10 wt. %, based on the starting material.

In the preferable embodiment of the invention, it is envisaged that the adsorber particles 4a, especially the activated carbon particles, are configured on the basis of a polymer-based spherical activated carbon (PBSAC; Polymer-based Spherical Activated Carbon) and/or wherein the adsorber particles 4a, especially the activated carbon particles, are configured from a polymer-based spherical activated carbon (PBSAC). This achieves particularly good adsorption results.

The activated carbon, which is preferably used according to the invention, has excellent adsorption properties overall, which are also characterized by the following specifications:

According to a preferred embodiment of the invention, it is envisaged that the adsorber particles 4a of the adsorption layer 4 are activated carbon particles, preferentially in the form of activated carbon particles in grain form (“grain carbon”) or activated carbon particles in spherical form (“spherical carbon”), preferably activated carbon particles in spherical form. In this way, particularly good adsorption results are obtained with regard to PAHs. Excellent results in terms of protection against PAHs can be achieved, especially if the following parameters and requirements are met.

Especially, it may be envisaged according to the invention that the activated carbon has a total pore volume, especially a total pore volume according to Gurvich, in the range of from 0.3 cm³/g to 3.8 cm³/g, especially in the range of from 0.4 cm³/g to 3.5 cm³/g, preferentially in the range of from 0.5 cm³/g to 3 cm³/g, more preferably in the range of from 0.6 cm³/g to 2.5 cm³/g, even more preferentially in the range of from 0.5 cm³/g to 1.5 cm³/g. This ensures a particularly good adsorption capacity.

In this context, it can be provided especially that at least 65%, especially at least 70%, preferentially at least 75%, preferably at least 80%, of the total pore volume, especially of the total pore volume according to Gurvich, of the activated carbon is formed by pores with pore diameters of at most 50 nm, especially by micro- and/or mesopores. This achieves a particularly good adsorption performance against PAHs.

Furthermore, it can be envisaged especially that 50% to 95%, especially 60% to 90%, preferentially 70% to 85%, of the total pore volume, especially of the total pore volume according to Gurvich, of the activated carbon are formed by pores with pore diameters of at most 50 nm, especially by micro- and/or mesopores. In this way, too, a particularly good adsorption performance with regard to PAHs is achieved.

Furthermore, it may especially be envisaged that 1% to 60%, especially 5% to 50%, preferentially 10% to 40%, preferably 15% to 35%, of the total pore volume, especially of the total pore volume according to Gurvich, of the activated carbon are formed by pores with pore diameters of more than 2 nm, especially by meso- and/or macropores.

It may especially be further envisaged that the activated carbon has a pore volume formed by pores with pore diameters of at most 2 nm (i.e. ≤2 nm), especially a micropore volume according to Carbon Black, in the range of from 0.05 cm³/g to 2.5 cm³/g, especially 0.15 cm³/g to 2 cm³/g, preferentially 0.3 cm³/g to 1.5 cm³/g, especially wherein 15% to 98%, especially 25% to 95%, preferentially 35% to 90%, of the total pore volume of the activated carbon is formed by pores with pore diameters of at most 2 nm, especially by micropores.

Furthermore, it may especially be envisaged that the activated carbon has a specific BET surface area in the range of from 600 m²/g to 4,000 m²/g, especially 800 m²/g to 3,500 m²/g, preferentially 1,000 m²/g to 3,000 m²/g, more preferably 1,200 m²/g to 2,750 m²/g, even more preferably 1,300 m²/g to 2,500 m²/g.

Moreover, according to the inventive invention, it can especially be envisaged that the activated carbon has a surface area formed by pores with pore diameters of at most 2 nm, especially by micropores, in the range of from 400 to 3,500 m²/g, especially 500 to 3,000 m²/g, preferentially 600 to 2,500 m²/g, preferably 700 to 2,000 m²/g.

In addition, it can especially be envisaged that the activated carbon has a surface area formed by pores with pore diameters in the range of from 2 nm to 50 nm, especially by mesopores, in the range of from 200 to 2,000 m²/g, especially 300 to 1,900 m²/g, preferentially 400 to 1,800 m²/g, preferably 500 to 1,700 m²/g.

Finally, it can especially be envisaged according to the invention that the activated carbon has an average pore diameter in the range of from 0.1 nm to 55 nm, especially 0.2 nm to 50 nm, preferentially 0.5 nm to 45 nm, preferably 1 nm to 40 nm.

An activated carbon (i.e. activated carbon particles, preferentially in the form of activated carbon particles in grain form (“grain carbon”) or activated carbon particles in spherical form (“spherical carbon”), preferably activated carbon particles in spherical form) preferably used according to the invention has an abrasion resistance, determined in accordance with ASTM D3802:2016, of at least 90%, especially of at least 95%, preferentially of at least 98%, more preferably of at least 99%, even more preferably of 100%. This ensures particularly good wear resistance under use conditions or in the wearing condition.

An activated carbon preferably used according to the invention (i.e. activated carbon particles, preferentially in the form of activated carbon particles in grain form (“grain carbon”) or activated carbon particles in spherical form (“spherical carbon”), preferably activated carbon particles in spherical form) also has a butane adsorption, determined in accordance with ASTM D5742-16, of at least 20%, especially of at least 30%, preferentially of at least 35%. A respective activated carbon especially has a butane adsorption, determined in accordance with ASTM D5742-16, in the range of from 20% to 90%, especially in the range of from 30% to 85%, preferentially in the range of from 35% to 80%. In this way, a particularly good adsorption performance with regard to PAHs is achieved. The butane activity is especially a measure of the micropore volume of the activated carbon (micropores are pores with diameters <2 nm). In accordance with the aforementioned method, the butane activity determines the ability of the activated carbon to adsorb butane from dry air. The butane activity is especially defined as the gradient with respect to the adsorbed mass per mass of the sample in the equilibrium state.

An activated carbon (i.e. activated carbon particles, preferentially in the form of activated carbon particles in granular form (“granular carbon”) or activated carbon particles in spherical form (“spherical carbon”), preferably activated carbon particles in spherical form) preferably used according to the invention also has an iodine number, determined in accordance with ASTM D4607:2014, of at least 900 mg/g, especially at least 1,000 mg/g, preferably at least 1,100 mg/g. Such activated carbon especially has an iodine number, determined in accordance with ASTM D4607:2014, in the range of from 900 mg/g to 2,200 mg/g, especially in the range of from 1,000 mg/g to 2,100 mg/g, preferentially in the range of from 1,100 mg/g to 2,000 mg/g. In this way, a particularly good adsorption performance with regard to PAHs is achieved. The iodine number can be evaluated especially as a measure of the available surface area of the activated carbon, which is predominantly provided by mesopores, especially by small mesopores; the aforementioned values of the iodine number show that the activated carbon has a high mesoporosity. Mesopores are pores with diameters ranging from 2 nm to 50 nm.

Suitable activated carbons according to the invention, as described above, are commercially available or commercially obtainable, especially from Blücher GmbH, Erkrath/Germany, or other commercial activated carbon manufacturers.

According to a particular embodiment of the present invention, the procedure is such that the adsorber particles 4a of the adsorption layer 4 are fixed and/or adhered to the adhesive layer 3 in such a way that at least 30% of the surface of the adsorber particles 4a, especially at least 40% of the surface of the adsorber particles 4a, preferentially at least 60% of the surface of the adsorber particles 4a, are not covered with adhesive (polymer) and/or that 30% to 95% of the surface of the adsorber particles 4a, especially 40% to 90% of the surface of the adsorber particles 4a, preferentially 60% to 85% of the surface of the adsorber particles 4a, are not covered with adhesive (polymer). This ensures good adsorption performance with respect to PAHs.

Especially, it may be envisaged in this context according to the inventive invention that at least 30% of the surface of the adsorber particles 4a, especially at least 40% of the surface of the adsorber particles 4a, preferentially at least 60% of the surface of the adsorber particles 4a, are not covered with adhesive (polymer).

Furthermore, it may be envisaged in this context that 30% to 95% of the surface of the adsorber particles 4a, especially 40% to 90% of the surface of the adsorber particles 4a, preferentially 60% to 85% of the surface of the adsorber particles 4a, are not covered with adhesive (polymer).

Suitable materials according to the invention with the aforementioned properties for the configuration of an adsorption layer 4 as described above or of adsorber particles 4a as described above are known and familiar as such to the skilled person working in this field, so that no further explanations are required in this regard. (cf. also the explanations above).

Regarding the particle and/or aerosol filter layer 5 provided according to the inventive embodiment, the following can be stated in this regard:

In the context of the present invention, it is especially envisaged that the particle and/or aerosol filter layer 5 is present and/or configured as a gas-permeable textile sheet-structure which comprises or is formed from a plurality of individual textile fibers with fiber diameters in the range of from 10 nm to 30 μm, preferably in the range of from 50 nm to 10 μm, preferentially with an area weight (especially determined as dry weight), especially determined in accordance with DIN EN 12127, preferentially after drying at 105 °C for 1 hour, in the range of from 2 g/m² to 100 g/m², especially in the range of from 5 g/m² to 90 g/m², more preferably in the range of from 10 g/m² to 80 g/m². This ensures good wearing comfort combined with good protective performance.

Furthermore, in the context of the present invention, it is especially envisaged that the particle and/or aerosol filter layer 5 has a weight per unit area (especially determined as dry weight) in the range of from 2 g/m² to 100 g/m², especially in the range of from 5 g/m² to 90 g/m², more preferably in the range of from 10 g/m² to 80 g/m², especially determined in accordance with DIN EN 12127, preferentially after drying at 105 °C for 1 hour.

It is usually envisaged in the context of the present invention that the textile fibers of the particle and/or aerosol filter layer 5 have fiber diameters in the range of from 10 nm to 30 μm, preferably in the range of from 50 nm to 10 μm. In this way, a good protective performance of the particle and/or aerosol filter layer 5 is ensured.

Furthermore, in the context of the present invention, it may especially be envisaged that synthetic fibers (man-made fibers) are used as textile fibers of the particle and/or aerosol filter layer 5, especially from the group of polyesters (PES); polyolefins, such as polyethylene (PE), polypropylene (PP), polyoxyethylene and polyoxypropylene; polyvinyl chlorides (CLF); polyvinylidene chlorides (CLF); acetates (CA); triacetates (CTA); polyacrylics (PAN), especially polyacrylonitriles; polyamides (PA); polyvinyl alcohol (PVAL); polyurethanes; polyvinyl esters; poly(meth)acrylates; polyvinylidene fluorides (PVDF); as well as mixtures thereof, more preferably polyurethanes; polyesters, polyolefins, polyamides, polyacrylonitriles, poly(meth)acrylates and polyvinylidene fluorides (PVDF) as well as mixtures thereof, even more preferably polyurethanes. Textile fibers made of polyurethanes are particularly preferable, as this ensures a high level of wearing comfort, especially with regard to the water vapor permeability of the material.

According to a preferable embodiment of the present invention, it is therefore envisaged that polyurethane fibers are used as textile fibers of the particle and/or aerosol filter layer 5.

It is usually envisaged that the particle and/or aerosol filter layer 5 is configured as a non-woven fabric or textile composite, especially a non-woven fabric, more preferably a non-woven fabric.

According to a particular embodiment of the present invention, it is envisaged that the particle and/or aerosol filter layer 5 is configured and/or present as a non-woven fabric or textile composite, especially a non-woven fabric, more preferably a non-woven fabric of polyurethane fibers.

Finally, it is envisaged in the context of the present invention that the particle and/or aerosol filter layer 5 is produced by electrospinning, meltblowing or a combination of these two methods, preferentially by a combination of electrospinning and meltblowing. This achieves a particularly good performance of the particle and/or aerosol filter layer 5. Most preferably is the production is by a combination of electrospinning and meltblowing, as this results in sections of different density in the particle and/or aerosol filter layer 5, which lead to excellent overall performance.

With regard to the arrangement and fixation of the particle and/or aerosol filter layer 5 within the protective material 1 or the protective clothing 8, the following should be noted:

Especially, it may be envisaged according to the invention that the particle and/or aerosol filter layer 5 is arranged directly on the adsorption layer 4, especially fixed on and/or to the adsorption layer 4, preferentially laminated thereto.

Furthermore, in the context of the present invention, it may especially be envisaged that the particle and/or aerosol filter layer 5 is fixed on and/or to the adsorption layer 4, preferentially by means of lamination, especially wherein the particle and/or aerosol filter layer 5 is also fixed on and/or to the cover layer 6, preferentially by means of lamination.

Finally, it may be envisaged in the context of the present invention that the particle and/or aerosol filter layer 5 is fixed on and/or to the adsorption layer 4, preferentially by means of lamination, and wherein the particle and/or aerosol filter layer 5 is also fixed on and/or to the cover layer 6, preferentially by means of lamination.

According to a particular embodiment of the present invention, it is further envisaged that the particle and/or aerosol filter layer 5 is a textile sheet-structure formed by and/or from textile fibers, especially synthetic textile fibers, preferentially polyurethane fibers, with a plurality of pores or meshes delimited by the textile fibers; especially wherein the particle and/or aerosol filter layer 5 has an average pore size or average mesh size of at most 200 μm, especially of at most 100 μm, preferentially of at most 75 μm, more preferably of at most 50 μm, even more preferably of at most 40 μm, further preferably of at most 10 μm, and/or especially wherein the particle and/or aerosol filter layer 5 has an average pore size or average mesh size in the range of from 0.5 μm to 200 μm, especially in the range of from 0.75 μm to 100 μm, preferentially in the range of from 1 μm to 75 μm, more preferably in the range of from 1.5 μm to 50 μm, even more preferably in the range of from 1.75 μm to 40 μm, further preferably in the range of from 2 μm to 10 μm. This ensures particularly good performance of the particle and/or aerosol filter layer 5 used according to the inventive method.

Furthermore, it may be envisaged in the context of the present invention that the particle and/or aerosol filter layer 5 comprises pores or meshes, especially a plurality of pores or meshes; especially wherein the mean pore size or mean mesh size is at most 200 μm, especially at most 100 μm, preferentially at most 75 μm, more preferably at most 50 μm, even more preferentially at most 40 μm, further preferably at most 10 μm, and/or especially wherein the average pore size or average mesh size is in the range of from 0.5 μm to 200 μm, especially in the range of from 0.75 μm to 100 μm, preferentially in the range of from 1 μm to 75 μm, more preferably in the range of from 1.5 μm to 50 μm, even more preferably in the range of from 1.75 μm to 40 μm, further preferably in the range of from 2 μm to 10 μm. In this way, a particularly good performance of the particle and/or aerosol filter layer 5 is achieved.

According to a further particular embodiment of the present invention, it may be envisaged that the particle and/or aerosol filter layer 5 is a textile sheet-structure formed by and/or from textile fibers, especially synthetic textile fibers, preferentially polyurethane fibers, with pores or meshes delimited by the textile fibers; especially wherein the ratio of the average pore size or mesh size to the average diameter of the textile fibers is in the range of from 0.1 to 2.000, especially in the range of from 1 to 500, preferentially in the range of from 5 to 350, more preferably in the range of from 10 to 300, even more preferably in the range of from 25 to 250.

Furthermore, the particle and/or aerosol filter layer 5 used in accordance with the invention is defined by a number of performance parameters in order to ensure a particularly good protective performance within the protective material 1 or protective clothing 8:

Especially, it is envisaged according to the invention that the particle and/or aerosol filter layer 5 has an average efficiency Eₘ according to DIN EN 779 (July 1993) of at least 40%, especially at least 50%, preferentially at least 70%, more preferably at least 90%, even more preferably at least 95%, and/or that the particle and/or aerosol filter layer 5 has an average separation efficiency Aₘ according to DIN EN 779 (July 1993) of at least 50%, especially at least 70%, preferentially at least 90%, more preferentially at least 95%, even more preferably at least 99%.

Furthermore, it is envisaged according to the invention that the particle and/or aerosol filter layer 5 has an integral initial permeability Dᵢ according to DIN EN 1822 (April 1998; DEHS aerosol, MPPS=0.1 to 0.3 μm) of at most 60%, especially at most 50%, preferentially at most 40%, more preferably at most 30%, even more preferably at most 20%.

In addition, it is envisaged in the context of the present invention that the particle and/or aerosol filter layer 5 has, at an incident flow velocity of 0.1 m/s, an average separation rate with respect to particles and/or aerosols with diameters in the range of from 0.1 to 0.3 μm of at least 80%, especially at least 90%, preferentially at least 95%, and/or wherein the particle and/or aerosol filter layer 5 has, at an incident flow velocity of 0.1 m/s, an average separation rate with respect to particles and/or aerosols with diameters ≥2 μm, especially ≥1.5 μm, preferably ≥1.0 μm, of at least 95%, especially at least 98%, preferably at least 99%.

It is also envisaged in the context of the present invention that the particle and/or aerosol filter layer 5 has a separation efficiency, especially a fractional separation efficiency, of at least 80%, especially at least 85%, preferentially at least 90%, determined in accordance with DIN EN 1822 at a pressure difference of 15 Pascal with potassium chloride (KCl) as test substance as minimum efficiency (MPPS, especially MPPS=0.1 μm to 0.3 μm).

The configuration of the particle and/or aerosol filter layer 5 in the manner described above ensures good protective performance combined with good wearing comfort, especially sufficient water vapor and air permeability.

As far as the thickness of the particle and/or aerosol filter layer 5 is concerned, this can vary over a wide range. Especially, it is envisaged according to the inventive embodiment that the particle and/or aerosol filter layer 5 has a thickness in the range of from 0.001 mm to 5 mm, especially in the range of from 0.01 mm to 2.5 mm, preferentially in the range of from 0.01 mm to 1 mm, even more preferably in the range of from 0.05 to 0.8 mm, especially determined in accordance with DIN EN ISO 5084.

Furthermore, it is preferable according to the invention that the particle and/or aerosol filter layer 5 is configured as a HEPA filter (High Efficiency Penetration or Particulate Air) or ULPA filter (Ultra Low Penetration or Particulate Air).

According to a particularly preferable embodiment of the present invention, it is envisaged that the particle and/or aerosol filter layer 5 is an air-permeable textile sheet-structure formed by and/or from textile fibers, especially polyurethane fibers, with fiber diameters in the range of from 10 nm to 30 μm, preferably 50 nm to 10 μm, in the form of a nonwoven fabric, preferably with an area weight (especially determined in accordance with DIN EN 12127, preferentially after drying at 105 °C for 1 hour) in the range of from 2 g/m² to 100 g/m², especially in the range of from 5 g/m² to 90 g/m², more preferably in the range of from 10 g/m² to 80 g/m², wherein the particle and/or aerosol filter layer 5 is configured by electrospinning, meltblowing or a combination of these two methods. This achieves a particularly good performance of the particle and/or aerosol filter layer 5 while at the same time providing good wearing comfort, especially water vapor permeability and gas permeability.

Suitable materials according to the invention with the aforementioned properties for configuring a particle and/or aerosol filter layer 5 as described above are known and familiar as such to the skilled person working in this field, so that no further explanations are required in this regard (cf. e.g. EP 1 825 899, U.S. Pat. No. 8,062,411, US 2007/0240576 A1, EP 2 160 228, U.S. Pat. No. 8,366,816 etc.).

As far as the textile cover layer 6 is concerned, the following should be stated:

Especially in the context of the present invention—as previously stated—it is envisaged that the cover layer 6 is configured and/or present as a preferentially gas-permeable textile sheet-structure.

Preferably, it is envisaged in accordance with the invention that the cover layer 6 is configured as an air-permeable textile sheet-structure, preferably as knitwear, especially as a crocheted fabric or knitted fabric.

Especially according to the inventive method, the cover layer 6 comprises or is formed from natural fibers and/or synthetic fibers (man-made fibers), preferably natural fibers, more preferably cotton fibers.

Furthermore, it may be envisaged according to the invention that the cover layer 6 comprises or is formed from natural fibers, more preferably cotton fibers, optionally in combination with synthetic fibers (man-made fibers).

Furthermore, it is possible to proceed according to the inventive method in such a way that the cover layer 6 comprises or is formed from natural fibers, more preferably cotton fibers, optionally in combination with synthetic fibers (man-made fibers), preferentially elastane fibers. In this way, good resistance and resilience are achieved in the state of use, since in this way the cover layer 6 has good elasticity and stretchability.

Finally, it can be envisaged according to the inventive invention that the cover layer 6 has a weight per unit area (especially determined as dry weight) in the range of from 10 g/m² to 275 g/m², especially in the range of from 15 g/m² to 175 g/m², preferentially in the range of from 25 g/m² to 150 g/m², more preferably in the range of from 30 g/m² to 100 g/m², especially determined in accordance with DIN EN 12127, preferentially after drying at 105 °C for 1 hour.

Suitable materials according to the invention with the aforementioned properties for the formation of a cover layer 6 as described above are known and familiar as such to the person skilled in the art working in this field, so that no further explanation is required in this regard.

Finally, as far as the further or second cover layer 7 is concerned, the following should be noted in this respect:

Especially in the context of the present invention, it may be envisaged that the further or second cover layer 7 is configured and/or present as a preferentially gas-permeable textile sheet-structure.

In addition, it may be envisaged in the context of the present invention that the further or second cover layer 7 is configured as an air-permeable textile sheet-structure, preferably as knitwear, especially as a crocheted fabric or knitted fabric.

In addition, within the scope of the present invention, the further or second cover layer 7 can comprise or be formed from natural fibers and/or synthetic fibers (man-made fibers), preferably natural fibers, more preferably cotton fibers.

Furthermore, within the scope of the present invention, the further or second cover layer 7 can comprise or be formed from natural fibers, more preferably cotton fibers, optionally in combination with synthetic fibers (man-made fibers).

According to a preferred embodiment of the invention, it may be envisaged that the further or second cover layer 7 comprises or is formed from natural fibers, more preferably cotton fibers, optionally in combination with synthetic fibers (man-made fibers), preferentially elastane fibers.

Finally, it may be envisaged in the context of the present invention that the further or second cover layer 7 has a weight per unit area (especially determined as dry weight) in the range of from 10 g/m² to 275 g/m², especially in the range of from 15 g/m² to 175 g/m², preferentially in the range of from 25 g/m² to 150 g/m², more preferably in the range of from 30 g/m² to 100 g/m², especially determined in accordance with DIN EN 12127, preferentially after drying at 105 °C for 1 hour.

Suitable materials according to the invention with the aforementioned properties for the formation of a further or second cover layer 7 as described above are known and familiar as such to the skilled person working in this field, so that no further explanation is required in this respect.

Based on the formation of the individual layers 2, 3, 4, 5, 6 and 7, a particularly high-performance protective material 1 or a particularly high-performance protective clothing 8 is provided, as stated at the beginning, accompanied by the advantages and special features described above.

In accordance with a more preferably embodiment of the present invention according to the first aspect of the invention, an object of the present invention is the use of a protective clothing 8, preferably in the form of a protective undergarment (protective underwear), for protecting persons against exposure to and/or contamination with polycyclic aromatic hydrocarbons (PAHs) released from a source of contamination when staying and/or working in locations in which polycyclic aromatic hydrocarbons are released or present and/or for protecting persons exposed to polycyclic aromatic hydrocarbons against contamination (“PAH contamination”), especially for preventing or minimizing contamination (“PAH contamination”), especially use as previously described according to the first aspect of the invention,
wherein the protective clothing 8 comprises or is formed from a textile protective material 1,
wherein the textile protective material 1 is configured as a multi-layered textile composite material comprising a plurality of interconnected layers 2, 3, 4, 5, 6,
wherein the textile protective material 1 comprises the following layers 2, 3, 4, 5, 6, preferably in the sequence mentioned below:
(a) a textile support layer 2, wherein the textile support layer 2 is present and/or configured as a preferably gas-permeable, textile sheet-structure, preferably as a knitwear, especially as crocheted fabric or knitted fabric, wherein the textile support layer 2 comprises or is formed from natural fibers and/or synthetic fibers (man-made fibers), preferably natural fibers, more preferably cotton fibers,
(b) an adhesive layer 3 applied to one side of the textile support layer 2, wherein the adhesive layer 3 is present and/or configured as a water vapor-permeable and/or gas-permeable and/or discontinuously formed adhesive layer, preferentially on the basis of an adhesive polymer, wherein the adhesive layer is either in the form of a dried and/or cured, especially crosslinked, broken adhesive polymer foam or in the form of a grid of a plurality of adhesive (polymer) dots distributed over the support layer 2, preferentially in the form of a dried and/or cured, especially crosslinked, broken adhesive polymer foam, and wherein the adhesive layer 3 is present partially penetrated into the textile support layer 2 and/or extending into the textile support layer 2,
(c) an adsorption layer 4 which is fixed and/or adhered to the adhesive layer 3 and is preferably discontinuously formed and/or gas-permeable, wherein the adsorption layer 4 comprises or is formed from a plurality of individual adsorber particles 4a, wherein the adsorber particles 4a of the adsorption layer 4 are activated carbon particles, preferentially in the form of activated carbon particles in granular form (“granular carbon”) or activated carbon particles in spherical form (“spherical carbon”), preferably in the form of activated carbon particles in spherical form, especially wherein the adsorber particles 4a of the adsorption layer 4 are fixed and/or adhered to the adhesive layer 3 in such a way that 30% to 95% of the surface of the adsorber particles 4a are not covered with adhesive (polymer),
(d) a particle and/or aerosol filter layer 5 arranged on the adsorption layer 4 and/or connected to the adsorption layer 4, preferentially a particle and aerosol filter layer 5, wherein the particle and/or aerosol filter layer 5 is present and/or configured as a gas-permeable textile sheet-structure in the form of a nonwoven material (nonwoven fabric, non-woven), which comprises or is formed from a plurality of individual textile fibers, especially polyurethane fibers, with fiber diameters in the range of from 10 nm to 5 μm, wherein the particle and/or aerosol filter layer 5 is produced by electro spinning, meltblowing or preferably by a combination of these two methods,
(e) optionally a cover layer 6 arranged on the particle and aerosol filter layer 5 and/or connected to the particle and aerosol filter layer 5, wherein the cover layer 6 is present and/or formed as a preferentially gas-permeable textile sheet-structure, preferably as knitwear, especially as crocheted fabric or knitted fabric, wherein the cover layer 6 comprises or is formed from natural fibers, more preferably cotton fibers, optionally in combination with synthetic fibers (man-made fibers), preferentially elastane fibers;
wherein the protective material 1 and/or the protective clothing 8 is configured to be gas-permeable, especially air-permeable, and/or water-vapor-permeable, preferentially gas-permeable, especially air-permeable, and water-vapor-permeable,
especially wherein the protective material 1 and/or the protective clothing 8 has a gas permeability, especially air permeability, at a flow resistance of 100 Pascal, especially determined in accordance with DIN EN ISO 9237, in the range of from 0.5 mm/s to mm/s, especially in the range of from 1 mm/s to 450 mm/s, preferentially in the range of from 2.5 mm/s to 400 mm/s, more preferably in the range of from 3.5 mm/s to mm/s, even more preferably in the range of from 5 mm/s to 250 mm/s; and/or
especially wherein the protective material 1 and/or the protective clothing 8 has a water vapor transmission resistance (Rₑₜ), especially determined in accordance with DIN EN 343:2019, of at most 15 m² Pa/Watt, especially of at most 10 m² Pa/Watt, preferably of at most 8 m² Pa/Watt, preferentially of at most 7 m² Pa/Watt, even more preferably of at most 6 m² Pa/Watt, further preferably of at most 5 m² Pa/Watt
and/or
wherein the protective material 1 and/or the protective clothing 8 has a separation efficiency, especially fractional separation efficiency, at a pressure difference of 15 Pascal with potassium chloride (KCl) as test substance as minimum efficiency (MPPS, especially MPPS=0.1 μm to 0.3 μm), of at least 90%, determined in accordance with DIN EN 1822;
and/or
wherein the protective material 1 and/or the protective clothing 8 has a butane adsorption, determined in accordance with ASTM D5742-16, of at least 20 g/m²;
especially wherein the protective clothing 8 is used as protective undergarment (protective underwear) in combination with protective outerwear, especially in combination with protective workwear, preferentially in combination with personal protective equipment; and/or
wherein the protective clothing 8 is configured and/or present in the form of at least one protective garment 8a, 8b, 8c, preferably in the form of a plurality of especially mutually complementary protective garments 8a, 8b, 8c, preferably in the form of a protective undergarment (protective underwear) and/or preferably for the protection of the lower body, upper body and head, especially selected from and/or in the form of (i) protective leg garment 8a, especially protective trousers, (ii) protective top garment 8b, especially protective shirt, protective T-shirt or protective sweater, (iii) protective headwear 8c, especially protective head cover, protective hood or protective balaclava, (iv) protective overall, protective one-piece suit or protective overall suit, (v) protective hand covering, especially protective glove, and (vi) protective foot covering, especially protective stocking, protective sock or protective footwear, as well as combinations thereof, preferably selected from and/or in the form of (i) protective leg garment 8a, especially protective pants, (ii) protective top garment 8b, especially protective shirt, protective T-shirt or protective sweater, especially including covering of the arms, and (iii) protective headwear 8c, especially protective head cover, protective hood or protective balaclava, as well as combinations thereof

According to a more preferably embodiment of the present invention according to the second aspect of the invention, an object of the present invention is the use of a textile protective material 1, especially in the form of a protective clothing 8, preferably in the form of a protective undergarment (protective underwear), for preventing or minimizing contamination with polycyclic aromatic hydrocarbons released from a contamination source (“PAH contamination”), especially for protecting persons exposed to polycyclic aromatic hydrocarbons (PAHs), especially use as previously described according to the second aspect of the invention,
wherein the textile protective material 1 is configured as a multi-layered textile composite material comprising a plurality of interconnected layers 2, 3, 4, 5, 6,
wherein the textile protective material 1 comprises the following layers 2, 3, 4, 5, 6, preferentially in the sequence mentioned below:
(a) a textile support layer 2, wherein the textile support layer 2 is present and/or configured as a preferentially gas-permeable, textile sheet-structure, preferably as knitwear, especially as crocheted fabric or knitted fabric, wherein the textile support layer 2 comprises or is formed from natural fibers and/or synthetic fibers (man-made fibers), preferably natural fibers, more preferably cotton fibers,
(b) an adhesive layer 3 applied to one side of the textile support layer 2, wherein the adhesive layer 3 is present and/or configured as a water-vapor-permeable and/or gas-permeable and/or discontinuously formed adhesive layer, preferentially based on an adhesive polymer, wherein the adhesive layer is either in the form of a dried and/or cured, especially crosslinked, broken adhesive polymer foam or in the form of a grid of a plurality of adhesive (polymer) dots distributed over the support layer 2, preferentially in the form of a dried and/or cured, especially crosslinked, broken adhesive polymer foam, and wherein the adhesive layer 3 is present partially penetrated into the textile support layer 2 and/or extending into the textile support layer 2,
(c) an adsorption layer 4 fixed and/or adhered to the adhesive layer 3, preferentially discontinuously formed and/or gas-permeable, wherein the adsorption layer 4 comprises or is formed from a plurality of individual adsorber particles 4a, wherein the adsorber particles 4a of the adsorption layer 4 are activated carbon particles, preferentially in the form of activated carbon particles in granular form (“granular carbon”) or activated carbon particles in spherical form (“spherical carbon”), preferably in the form of activated carbon particles in spherical form,
especially wherein the adsorber particles 4a of the adsorption layer 4 are fixed and/or adhered to the adhesive layer 3 in such a way that 30% to 95% of the surface of the adsorber particles 4a are not covered with adhesive (polymer),
(d) a particle and/or aerosol filter layer 5 arranged on the adsorption layer 4 and/or connected to the adsorption layer 4, preferentially a particle and aerosol filter layer 5, wherein the particle and/or aerosol filter layer 5 is present and/or configured as a gas-permeable textile sheet-structure in the form of a non-woven material (non-woven fabric), which comprises or is formed from a plurality of individual textile fibers, especially polyurethane fibers, with fiber diameters in the range of from 10 nm to 5 μm, wherein the particle and/or aerosol filter layer 5 is produced by electrospinning, meltblowing or preferably by a combination of these two methods,
(e) optionally a cover layer 6 arranged on the particle and aerosol filter layer 5 and/or connected to the particle and aerosol filter layer 5, wherein the cover layer 6 is present and/or configured as a preferentially gas-permeable textile sheet-structure, preferably as knitwear especially as crocheted fabric or knitted fabric, wherein the cover layer 6 comprises or is formed from natural fibers, more preferably cotton fibers, optionally in combination with synthetic fibers (man-made fibers), preferentially elastane fibers;
wherein the protective material 1 and/or the protective clothing 8 is configured to be gas-permeable, especially air-permeable, and/or water-vapor-permeable, preferentially gas-permeable, especially air-permeable, and water-vapor-permeable,
especially wherein the protective material 1 and/or the protective clothing 8 has a gas permeability, especially air permeability, at a flow resistance of 100 Pascal, especially determined in accordance with DIN EN ISO 9237, in the range of from 0.5 mm/s to 500 mm/s, especially in the range of from 1 mm/s to 450 mm/s, preferentially in the range of from 2.5 mm/s to 400 mm/s, more preferably in the range of from 3.5 mm/s to 300 mm/s, even more preferably in the range of from mm/s to 250 mm/s; and/or
especially wherein the protective material 1 and/or the protective clothing 8 has a water vapor transmission resistance (Rₑₜ), especially determined in accordance with DIN EN 343:2019, of at most 15 m² Pa/Watt, especially of at most 10 m² Pa/Watt, preferably of at most 8 m² Pa/Watt, preferentially of at most 7 m² Pa/Watt, even more preferably of at most 6 m² Pa/Watt, further preferably of at most 5 m² Pa/Watt;
and/or
wherein the protective material 1 and/or the protective clothing 8 has a separation efficiency, especially fractional separation efficiency, of at least 90%, determined in accordance with DIN EN 1822 at a pressure difference of 15 Pascal with potassium chloride (KCl) as test substance as minimum efficiency (MPPS, especially MPPS=0.1 μm to 0.3 μm);
and/or
wherein the protective material 1 and/or the protective clothing 8 has a butane adsorption, determined in accordance with ASTM D5742-16, of at least 20 g/m²;
especially wherein the protective clothing 8 is used as protective undergarment (protective underwear) in combination with protective outerwear, especially in combination with protective workwear, preferentially in combination with personal protective equipment; and/or
wherein the protective clothing 8 is formed and/or present in the form of at least one protective garment 8a, 8b, 8c, preferentially in the form of a plurality of especially mutually complementary protective garments 8a, 8b, 8c, preferably in the form of a protective undergarment (protective underwear) and/or preferably for the protection of the lower body, 8a, especially protective trousers, (ii) protective top garment 8b, especially protective shirt, protective T-shirt or protective sweater, (iii) protective headwear 8c, especially protective head cover, protective hood or protective balaclava, (iv) protective overall, protective one-piece suit or protective overall suit, (v) protective hand covering, especially protective glove, and (vi) protective foot covering, especially protective stocking, protective sock or protective footwear, as well as combinations thereof, preferably selected from and/or in the form of (i) protective leg garment 8a, especially protective pants, (ii) protective top garment 8b, especially protective shirt, protective T-shirt or protective sweater, especially including covering of the arms, and (iii) protective headwear 8c, especially protective head cover, protective hood or protective balaclava, as well as combinations thereof.

Furthermore, it may be envisaged according to the invention that the protective material 1 used according to the invention and/or the protective clothing 8 used according to the invention is provided with a flame-retardant or flame-resistant finish, especially with a flame-retardant or flame-resistant finish based on halogen- and/or phosphorus-containing flame retardants, preferably phosphate esters, phosphonates, phosphinates. It can especially be provided in accordance with the invention that the flame-retardant or flame-resistant finish has been achieved by impregnating the protective material 1 and/or the protective clothing 8 with the flame retardant. This achieves an even greater protective effect.

The inventive uses according to both the first aspect of the invention and the second aspect of the invention enable numerous applications.

Thus, the uses according to the first aspect of the invention as well as according to the second aspect of the invention can be used especially for the protection of persons against gases containing polycyclic aromatic hydrocarbons, especially exhaust gases or flue gases, from combustion and/or high-temperature processes, especially for the protection of persons against gases containing polycyclic aromatic hydrocarbons, especially exhaust gases or flue gases, from, of or in fires, coking plants, foundries, steelworks, smelting processes, metal and steel production and processing processes, blast furnace processes, waste incineration processes, asphalt production and processing processes, glass production and processing processes, refractory production and processing processes.

Furthermore, the inventive uses according to both the first aspect of the invention and the second aspect of the invention can be used especially in cases in which the polycyclic aromatic hydrocarbons originate from gases, especially exhaust gases or flue gases, from combustion and/or high-temperature processes, especially from gases, especially exhaust gases or flue gases, from, of or in fires, coking plants, foundries, steelworks, smelting processes, metal and steel production and processing processes, blast furnace processes, waste incineration processes, asphalt production and processing processes, glass production and processing processes, refractory production and processing processes.

Furthermore, the inventive uses according to both the first aspect of the invention and the second aspect of the invention may especially be used in cases where the persons to be protected are firefighters or persons working in coking plants, foundries, steelworks, smelting processes, metal and steel production and processing processes, blast furnace processes, waste incineration processes, asphalt production and processing processes, glass production and processing processes, refractory production and processing processes, preferably firefighters.

Preferably, the inventive uses according to both the first aspect of the invention and the second aspect of the invention can be used especially for protecting firefighters against gases containing polycyclic aromatic hydrocarbons, especially exhaust gases or flue gases, from fires. Especially, the protective clothing 8 can be used as protective undergarment (protective underwear) in combination with protective outerwear, especially in combination with protective workwear, preferentially in combination with personal protective equipment, preferably in combination with protective outerwear for firefighters in accordance with DIN EN 469. Especially, the protective clothing 8 can be used and/or can be present in this context in the form of a protective undergarment (protective underwear), wherein the protective clothing 8 is present and/or configured as a combination of (i) protective leg garment 8a, especially protective trousers, (ii) protective top garment 8b, especially protective shirt, protective T-shirt or protective sweater, especially including covering of the arms, and (iii) protective headwear 8c, especially protective head cover or protective balaclava

Furthermore, another object of the present invention is—according to a third aspect of the present invention—a method for protecting persons against exposure to and/or contamination with polycyclic aromatic hydrocarbons (PAHs) released from a contamination source when staying and/or working in locations in which polycyclic aromatic hydrocarbons are released or present, and/or for protecting persons exposed to polycyclic aromatic hydrocarbons against contamination (“PAH contamination”), especially for preventing or minimizing contamination (“PAH contamination”),
wherein the persons are equipped and/or provided, especially clothed, with protective clothing 8, preferably in the form of protective undergarments (protective underwear),
wherein the protective clothing 8 comprises or is formed from a textile protective material 1,
wherein the textile protective material 1 is configured as a multi-layered textile composite material comprising a plurality of interconnected layers 2, 3, 4, 5, 6,
wherein the textile protective material 1 comprises the following layers 2, 3, 4, 5, 6, preferably in the sequence mentioned below:
(a) a textile support layer 2, wherein the textile support layer 2 is present and/or configured as a preferentially gas-permeable textile sheet-structure,
(b) an adhesive layer 3 applied to one side of the textile support layer 2, wherein the adhesive layer 3 is present and/or configured as a water-vapor-permeable and/or gas-permeable and/or discontinuously formed adhesive layer, preferentially based on an adhesive polymer,
(c) an adsorption layer 4 fixed and/or adhered to the adhesive layer 3, preferentially discontinuously formed and/or is gas-permeable, wherein the adsorption layer 4 comprises or is formed from a plurality of individual adsorber particles 4a,
(d) a particle and/or aerosol filter layer 5 arranged on the adsorption layer 4 and/or connected to the adsorption layer 4, preferentially a particle and aerosol filter layer 5, wherein the particle and/or aerosol filter layer 5 is present and/or configured as a gas-permeable textile sheet-structure which comprises or is formed from a plurality of individual textile fibers,
(e) optionally a cover layer 6 arranged on the particle and aerosol filter layer 5 and/or connected to the particle and aerosol filter layer 5, wherein the cover layer 6 is present and/or configured as a preferentially gas-permeable textile sheet-structure

Especially, the method according to the invention is used for protecting persons against gases containing polycyclic aromatic hydrocarbons, especially exhaust gases or flue gases, from combustion and/or high-temperature processes, especially for protecting persons against gases containing polycyclic aromatic hydrocarbons, especially exhaust gases or flue gases, from, of or in fires, coking plants, foundries, steelworks, smelting processes, metal and steel production and processing processes, blast furnace processes, waste incineration processes, asphalt production and processing processes, glass production and processing processes, refractory production and processing processes.

More preferably, the method according to the inventive process is used for protecting firefighters against gases containing polycyclic aromatic hydrocarbons, especially exhaust gases or flue gases, from fires.

Especially—as previously described in connection with the inventive uses—the protective clothing 8 can be used as protective undergarment (protective underwear) in combination with protective outerwear, especially in combination with protective workwear, preferentially in combination with personal protective equipment, preferably in combination with protective outerwear for firefighters according to DIN EN 469.

Especially, as previously described in connection with the inventive uses, the protective clothing 8 can still be used and/or be present in the form of protective undergarments (protective underwear), wherein the protective clothing 8 is present and/or configured as a combination of (i) protective leg garment 8a, especially protective trousers, (ii) protective top garment 8b, especially protective shirt, protective T-shirt or protective sweater, especially including covering of the arms, and (ii) protective headwear 8c, especially protective head cover or protective balaclava.

For further details of the previously described method according to the third aspect of the invention, reference can be made to the above explanations of the previously described uses according to the first and second aspects of the invention, wherein these explanations apply accordingly with respect to the method according to the invention.

Similarly, another object of the present invention—according to a fourth aspect of the present invention—is also a protective clothing combination, especially for protecting persons against exposure to and/or contamination with polycyclic aromatic hydrocarbons (PAHs) released from a contamination source when staying and/or working in locations in which polycyclic aromatic hydrocarbons are released or present, and/or especially for protecting persons exposed to polycyclic aromatic hydrocarbons against contamination (“PAH contamination”), especially for preventing or minimizing contamination (“PAH contamination”) and/or especially for preventing or minimizing contamination with polycyclic aromatic hydrocarbons released from a contamination source (“PAH contamination”), preferentially for protecting persons exposed to polycyclic aromatic hydrocarbons (PAHs),
wherein the protective clothing combination has:
(A) protective outerwear, especially protective workwear, preferentially personal protective equipment, preferably protective outerwear for firefighters in accordance with DIN EN 469; and
(B) protective clothing 8 in the form of a protective undergarment (protective underwear), especially wherein the protective clothing 8 is present and/or configured as a combination of (i) protective leg garment 8a, especially protective trousers, (ii) protective top garment 8b, especially protective shirt, protective T-shirt or protective sweater, especially including covering of the arms, and (iii) protective headwear 8c, especially protective head cover or protective balaclava;
wherein the protective clothing 8 comprises or is formed from a textile protective material 1,
wherein the textile protective material 1 is configured as a multi-layered textile composite material comprising a plurality of interconnected layers 2, 3, 4, 5, 6,
wherein the textile protective material 1 comprises the following layers 2, 3, 4, 5, 6, preferentially in the sequence mentioned below:
(a) a textile support layer 2, wherein the textile support layer 2 is present and/or configured as a preferentially gas-permeable textile sheet-structure,
(b) an adhesive layer 3 applied to one side of the textile support layer 2, wherein the adhesive layer 3 is present and/or configured as a water-vapor-permeable and/or gas-permeable and/or discontinuously formed adhesive layer, preferentially based on an adhesive polymer,
(c) an adsorption layer 4 fixed and/or adhered to the adhesive layer 3, preferentially discontinuously formed and/or gas-permeable, wherein the adsorption layer 4 comprises or is formed from a plurality of individual adsorber particles 4a,
(d) a particle and/or aerosol filter layer 5 arranged on the adsorption layer 4 and/or connected to the adsorption layer 4, preferentially a particle and aerosol filter layer 5, wherein the particle and/or aerosol filter layer 5 is present and/or configured as a gas-permeable textile sheet-structure which comprises or is formed from a plurality of individual textile fibers,
(e) optionally a cover layer 6 arranged on the particle and aerosol filter layer 5 and/or connected to the particle and aerosol filter layer 5, wherein the cover layer 6 is present and/or configured as a preferentially gas-permeable textile sheet-structure

For further details regarding the protective clothing combination according to the fourth aspect of the invention described above, reference can be made to the above explanations of the other inventive aspects of the invention described above (i.e. first to third aspects of the invention), wherein these explanations apply accordingly with respect to the protective clothing combination according to the invention.

Finally, a further object of the present invention—in accordance with a fifth aspect of the present invention—is also the use of a protective clothing combination according to the invention described above under the fourth aspect of the invention for protecting persons against exposure to and/or contamination with polycyclic aromatic hydrocarbons (PAHs) released from a contamination source when staying and/or working in locations in which polycyclic aromatic hydrocarbons are released or present, and/or for protecting persons exposed to polycyclic aromatic hydrocarbons against contamination (“PAH contamination”), especially for preventing or minimizing contamination (“PAH contamination”) or the use of the protective clothing combination according to the invention described above under the fourth aspect of the invention for preventing or minimizing contamination with polycyclic aromatic hydrocarbons released from a contamination source (“PAH contamination”), especially for protecting persons exposed to polycyclic aromatic hydrocarbons (PAHs), respectively.

For further details of the use according to the fifth aspect of the invention described above, reference can be made to the above explanations of the other aspects of the invention according to the invention described above (i.e. first to fourth aspects of the invention), wherein these explanations apply accordingly with respect to the use according to the fifth aspect of the invention.

Thus, the overall result with respect to the present invention is a highly efficient as well as extremely economical and furthermore also highly sustainable concept for achieving a high-performance protective function against polycyclic aromatic hydrocarbons both in gaseous and in particulate-bound form, so that with the present invention a highly effective protection of persons against exposure to and/or contamination with polycyclic aromatic hydrocarbons released from a contamination source when staying and/or working in locations in which PAHs are released or present, or a highly effective protection against exposure of persons exposed to PAHs against PAH contamination, especially to prevent or minimize PAH contamination, respectively, can be provided, wherein it is of particular advantage that the inventive concept can be implemented or realized, if necessary, in combination with protective outerwear, especially protective workwear, preferably personal protective equipment (PPE), existing or customary in the area concerned. The result is a highly efficient and powerful as well as extremely economical and also highly sustainable protection concept against polycyclic aromatic hydrocarbons in gaseous and particulate form to protect people against PAH contamination.

Further embodiments, modifications, variations, configurations, special features and advantages of the present invention are readily recognizable and realizable by a person skilled in the art when reading the description, without departing from the scope of the present invention.

The present invention is illustrated by means of the following examples, which are in no way intended to limit the present invention.

### EXAMPLES

### Provision of the Textile Protective Materials and Protective Clothing Used in the Form of Undergarments (Underwear)

Different textile protective materials are produced, namely two protective materials used according to the invention (protective materials A1 and A2) and two comparative protective materials (protective materials B1 and B2), wherein all the aforementioned protective materials A1, A2, B1 and B2 are then each processed in a manner known per se to form a three-part underwear according to FIG. 3 (underwear based on a three-part combination of (i) protective trousers, (ii) protective shirt including covering of the arms and (iii) protective hood/protective balaclava). This results in four different underwear combinations, each consisting of three parts, which are referred to below as “protective underwear A1” and “protective underwear A2” (each according to the inventive) as well as “protective underwear B1” and “protective underwear B2” (each comparison) according to the protective materials on the basis of which they are produced. Another protective underwear for comparison (“protective underwear B3”) is a commercially available two-layer firefighting underwear with an outer wool layer and an inner viscose layer, as used by European firefighters.

The terms “inner” and “outer” (e.g. inner layer and outer layer etc.), as used in the context of the present invention, refer to the state of use or state of wear. Especially, the inner layer of the textile protective materials or protective garments faces away from the PAH contamination source or towards the wearer and lies on the skin, while the outer layer of the textile protective materials or protective garments faces towards the PAH contamination source or away from the wearer.

The respective protective underwear “protective underwear A1” and “protective underwear A2” according to the invention have a structure of the protective material as shown in FIG. 1 (however without the further or second cover layer 7), wherein the cover layer 6 forms the outer layer and the textile support layer 2 forms the inner layer. The layered structure of the “protective underwear A1” and the “protective underwear A2” is thus as follows (wherein the reference signs have the previously indicated meaning):

2 (inside)/3/4/5/6 (outside)

The “protective underwear A1” and the “protective underwear A2” differ from one another in that in the “protective underwear A1” the adhesive layer 3 is in the form of a dried and cured, i.e. crosslinked, broken adhesive polymer foam (corresponds to FIG. 2A), whereas in the case of “protective underwear A2”, the adhesive layer 3 is configured in the form of a regular grid of a large number of individual adhesive (polymer) dots distributed over the textile support layer 2 (corresponds to FIG. 2B).

The comparative underwear “protective underwear B1” differs from the inventive “underwear A1” by the absence of a particle and aerosol filter layer 5 (i.e. the layer structure of the “protective underwear B1” is as follows: 2 (inside)/3/4/6 (outside)).

The comparative underwear “protective underwear B2”, on the other hand, differs from the inventive “underwear A1” by the absence of an adsorption layer 4 (i.e. the layer structure of the “protective underwear B2” is as follows: 2 (inside)/3/5/6 (outside)).

The nature of the individual layers is as follows:

As the textile support layer 2 a gas-permeable textile fabric in the form of knitwear (namely knitted fabric) made of cotton fibers is used.

The adhesive layer 3 is in each case configured as a water-vapor and gas permeable or discontinuous adhesive layer based on a polyurethane adhesive polymer and is applied to the textile support layer 2 in such a way that it partially penetrates into the textile support layer 2 or that it extends into the textile support layer (2) (application quantity: approx. 30 g/m² dry weight).

The discontinuously formed and gas-permeable adsorption layer 4, which is fixed or adhered to the textile support layer 2 by means of the adhesive layer 3, is formed by a plurality of individual adsorber particles 4a in the form of activated carbon particles in spherical shape (“spherical carbon”) (coating quantity: approx. 38 g/m²,), wherein the adsorber particles 4a are fixed or adhered to the adhesive layer 3 in such a way that more than 50% of the surface of the adsorber particles 4a are not covered with adhesive (polymer) (confirmed by analysis using SEM images).

The properties of the activated carbon used as adsorber particle 4a are as follows: Total pore volume (total pore volume according to Gurvich): approx. 1.3 cm³/g, of which >65% by pores with pore diameters <50 nm; specific BET surface area: approx. 2,200 m²/g; average diameter of the particles: approx. 0.06 mm; activated carbon particles based on a polymer-based spherical activated carbon (PBSAC); activated carbon particles produced by carbonization and subsequent activation of a synthetic particulate starting material based on organic polymer particles (=sulfonated organic polymers based on divinylbenzene crosslinked polystyrene). The activated carbon has an abrasion resistance, determined according to ASTM D 3802:2016, of approx. 100%. The butane adsorption, determined according to ASTM D5742-16, is approx. 55% and the iodine number, determined according to ASTM D4607:2014, is approx. 1,250 mg/g.

The protective materials of underwear A1 and A2 as well as B1 and B2 are produced by laminating the individual layers in a manner known per se.

First, the adhesive layer 3 is applied to the textile support layer 2 for the production of the protective materials A1, A2, B1 and B2:

In the case of the protective materials A1 and B1, the procedure is as described in WO 2017/016694 A1 (see also FIG. 2A) and, for this purpose, an aqueous-based solution or dispersion of a polyurethane adhesive polymer, previously foamed under mechanical energy input, is applied to the textile support layer 2 (wet application quantity: 60 g/m² at a thickness of about 0.2 to 0.4 mm; dispersion adhesive) (accompanied by partial penetration of the adhesive polymer into the textile support layer 2), to which the adsorber particles 4a are then applied or fixed by scattering and lightly pressing on while the adhesive polymer is still wet, with the proviso that more than 50% of the surface of the adsorber particles 4a is not covered with adhesive polymer; this is followed by drying and curing of the solution or dispersion of the adhesive polymer for further fixation of the adsorber particles 4a and for the formation or maintenance of the dried and cured broken adhesive polymer foam or the cured adhesive layer 3 with the broken foam (drying and curing at temperatures in the range between 100 °C and 150 °C). In the case of the protective material B2, the procedure is analogous, but the application of the absorption layer 4 or the adsorber particles 4a is omitted.

In the case of the protective material A2 (see also FIG. 2B), on the other hand, a melted polyurethane-based adhesive polymer (hot-melt adhesive) is applied or printed on via a stencil in the form of a regular grid of a large number of individual adhesive polymer dots distributed over the textile support layer 2 (accompanied by partial penetration of the adhesive polymer into the textile support layer 2), to which the adsorber particles 4a are then applied or fixed in the still un-crosslinked state of the adhesive polymer by scattering and lightly pressing, with the proviso that more than 50 % of the surface of the adsorber particles 4a are not covered with adhesive polymer; this is followed by curing or crosslinking of the adhesive polymer for further fixing of the adsorber particles 4a.

The remaining layers 5 and 6 (i.e. particle and aerosol filter layer 5 and textile cover layer 6) are then laminated onto the adsorption layer 4 with the plurality of individual adsorber particles 4a, which is fixed to the textile support layer 2 in this way by means of the adhesive layer 3, in a manner known per se in the case of the protective materials A1 and A2 (i.e. particle and aerosol filter layer 5 as well as textile cover layer 6); in the case of the comparative protective material B1, however, the particle and aerosol filter layer 5 is omitted (i.e. only the textile cover layer 6 is laminated directly onto the adsorption layer 4).

The production of the comparative protective material B2 is carried out in a corresponding manner, but with the adsorption layer 4 being omitted as described above.

This results in the two protective materials A1 and A2 on the one hand and the two comparative protective materials (i.e. protective materials B1 and B2) on the other hand, wherein all the aforementioned protective materials A1, A2, B1 and B2 are each processed or made up in a known manner to form a three-part underwear as shown in FIG. 3 (underwear based on a three-part combination of (i) protective trousers, (ii) protective shirt including covering of the arms and (iii) protective hood/protective balaclava).

This results in four different underwear combinations, each consisting of three parts, namely “protective underwear A1” and “protective underwear A2” (each according to the invention) as well as “protective underwear B1” and “protective underwear B2” (each comparison).

Various properties of the protective underwear are then determined and recorded.

The following properties are determined for the inventive protective materials or protective underwear A1 and A2:
total surface weight (determined as dry weight according to DIN EN 12127, after drying for 1 hour at 105 °C): (340±20) g/m²
thickness (total cross-section thickness) according to DIN EN ISO 5084: approx. 1.2 mm
air permeability according to DIN EN ISO 9237 (flow resistance): at least 5 mm/s
water vapor transmission resistance (Rₑₜ) according to DIN EN 343:2019: maximum 15 m² Pa/Watt
burst pressure in accordance with DIN EN ISO 13938-2: at least 100 kPa (kilopascals)
maximum tensile force (elongation) according to DIN EN ISO 13934-1: >200 Newton
elongation load/elongation capacity (elongation) in longitudinal and transverse direction according to DIN 53835-14 at 20 Newton: at least 5%
shrinkage in longitudinal and transverse direction according to DIN EN 5077: maximum 5%
separation efficiency, especially fractional separation efficiency: at least 90% (determined according to DIN EN 1822 at a pressure difference of 15 Pascal with potassium chloride (KCl) as test substance as minimum efficiency (MPPS, especially MPPS=0.1 μm to 0.3 μm))
butane adsorption (determined according to ASTM D 5742-16): at least 20 g/m²

### Application Tests of the Textile Protective Materials and Protective Clothing Provided

The previously described underwear A1 (invention), A2 (invention), B1 (comparison), B2 (comparison) and B3 (comparison) are tested with regard to their protective effect against polycyclic aromatic hydrocarbons (PAH) in the context of exposure to fire gases. For this purpose, the aforementioned underwear is combined with standard firefighter protective outerwear in accordance with DIN EN 469 and a standard breathing apparatus.

The test subjects are first fitted with appropriate PAH sensors, which are glued to the skin of the test subjects in the neck area, chest area, upper arm area, thigh area and hip area. Polyurethane foam-based passive air samplers are used as PAH sensors (as described in: B. Strandberg et al. “Evaluation of polyurethane foam passive air sampler (PUF) as a tool for occupational PAH measurements” in: Sphere, Vol. 190, January 2018, pages 35 to 42), which are applied directly to the skin in each case and analyzed accordingly after performing the tests. The polyurethane foam-based PAH sensors are configured in a circular shape (diameter approx. 14 cm) and are applied and attached directly to the skin by means of adhesive.

Five firefighters each are equipped with the above-mentioned protective combination of firefighter protective clothing in accordance with DIN EN 469 with breathing apparatus on the one hand and the relevant underwear on the other (i.e. five firefighters each with underwear A1, five firefighters each with underwear A2, five firefighters each with underwear B1, five firefighters each with underwear B2 and five firefighters each with underwear B3). These test subjects were previously fitted with the PAH sensors on their skin at the body sites mentioned.

For test purposes, a defined fire is ignited in a closed steel container, accompanied by defined smoke gas development. The PAH load of the flue gas is also analyzed and the corresponding PAH substances are analytically determined and identified. The PAH substances found include more than 32 different substituted and unsubstituted naphthalenes, naphthylenes, naphthenes, biphenyls, fluorenes, anthracenes, phenanthrenes, pyrenes, perylenes, chrysenes and coronenes.

The firefighters equipped with the different underwear are then brought into contact with and exposed to the corresponding fire gases in groups of five with the five different protective underwear in the fire container. Each fire test (“smoke dive”) in the container lasts 25 minutes (i.e. 25-minute smoke dives).

After completion of the tests, the PAH sample collectors are analyzed with regard to the PAH content (usual analysis by means of solvent extraction and subsequent purification by column chromatography, followed by GC/MS analysis of the total of more than 32 individual PAH substances). The quantification is carried out as PAH quantity in the unit nanogram per sampling sensor (averaged over all PAH sensors of a respective test person and then averaged over the 5 test persons of a group).

These values are then used to determine the average breakthrough rate and finally the so-called protection factor (as described above, the so-called protection factor in relation to PAH represents the reciprocal value of the penetration in relation to PAH, i.e. if, for example, the protection factor is 100, this means that no more than 1/100 of the PAH contamination penetrates the material; a protection factor of 100 therefore means a penetration or breakthrough of only 1% of the PAH contamination).

The tests for the inventive underwear A1 and A2 are then repeated in the same way after the respective protective underwear has been washed ten times (washing according to DIN EN ISO 6330:2013-02); the results are evaluated in the same way.

The total amount of PAHs measured on the skin in the case of underwear B3 is on average around 6% of the total amount of PAHs present in the smoke from the fire; this corresponds to an approximately 15-fold reduction in the amounts of PAHs (i.e. protection factor: 15). In the case of underwear B1 and B2, which are also not according to the invention, this protection factor is approx. 550 and approx. 500, respectively. In the case of underwear A1 and A2 according to the invention, on the other hand, the protection factor is 3,400 and 3,340 respectively. After washing 10 times (washing according to DIN EN ISO 6330:2013-02), the protection factor is still 660 and 610, respectively.

The concept according to the invention can thus achieve an excellent protective effect against PAH contamination in gaseous and particulate form, wherein the concept according to the invention can also be retrofitted or integrated into existing protective equipment, which all the more emphasizes the efficiency, economy and sustainability of the inventive solution approach.

### LIST OF REFERENCE SYMBOLS

1 textile protective material
2 textile support layer
3 adhesive layer
4 adsorption layer
4a adsorber particles
5 particle and/or aerosol filter layer
6 cover layer
7 further or second cover layer
8 protective clothing
8a protective leg garment
8b protective top
8c protective headwear

1-70. (canceled)

71. A method for protecting a person that is exposed to polycyclic aromatic hydrocarbons against a contamination with said polycyclic aromatic hydrocarbons,
wherein the method comprises a step of equipping the person that is to be protected with a protective clothing in the form of a protective undergarment,
wherein the protective clothing comprises a textile protective material,
wherein the textile protective material is a multi-layered textile composite material comprising a plurality of interconnected layers,
wherein the textile protective material comprises the following layers in the sequence mentioned as follows:
(a) a textile support layer, wherein the textile support layer is configured as a gas-permeable textile sheet-structure,
(b) an adhesive layer applied to one side of the textile support layer, wherein the adhesive layer is configured as a water-vapor-permeable and gas-permeable and discontinuously formed adhesive layer,
(c) an adsorption layer fixed to the adhesive layer, wherein the adsorption layer comprises a plurality of individual adsorber particles,
(d) a particle- and aerosol-filter layer arranged on the adsorption layer, wherein the particle- and aerosol-filter layer is configured as a gas-permeable textile sheet-structure comprising a plurality of individual textile fibers.

72. The method according to claim 71,
wherein the textile protective material further comprises the following layer:
(e) a cover layer arranged on the particle- and aerosol-filter layer, wherein the cover layer is configured as a gas-permeable textile sheet-structure.

73. The method according to claim 71,
wherein the protective clothing is configured to protect the lower body, the upper body and the head.

74. The method according to claim 71,
wherein the protective clothing is configured in the form of a combination of mutually complementary pieces of protective undergarment.

75. The method according to claim 71,
wherein the protective clothing is configured in the form of a combination of mutually complementary pieces of protective undergarment, wherein the combination comprises (i) a protective leg garment, (ii) a protective top garment including covering of the arms and (iii) a protective headwear.

76. The method according to claim 71,
wherein the protective clothing and the protective material are used during the wearing state in such a way that the particle- and aerosol-filter layer is facing the source of contamination.

77. The method according to claim 72,
wherein the protective clothing and the protective material are used during the wearing state in such a way that the cover layer is facing away from the wearer of the protective clothing and forms an outer layer of the protective clothing and of the protective material.

78. The method according to claim 71,
wherein the protective clothing is used as a protective undergarment in combination with a protective outerwear.

79. The method according to claim 71,
wherein the protective material and the protective clothing are each configured to be gas-permeable and water-vapor-permeable.

80. The method according to claim 71,
wherein the protective material and the protective clothing are each configured to be washable.

81. The method according to claim 71,
wherein the protective material fulfills at least one of the following characteristics (1) to (vii):
(i) the protective material has a gas permeability at a flow resistance of 100 Pascal, determined in accordance with DIN EN ISO 9237, in the range of from 0.5 mm/s to 500 mm/s;
(ii) the protective material has a water vapor transmission resistance Rₑₜ, determined in accordance with DIN EN 343:2019, of at most 15 m² Pa/Watt;
(iii) the protective material has a thickness in the range of from 0.25 mm to 25 mm, determined in accordance with DIN EN ISO 5084;
(iv) the protective material has a burst pressure, determined in accordance with DIN EN ISO 13938-2, in the range of from 50 kPa to 1,000 kPa;
(v) the protective material has a maximum tensile force in at least one direction, determined in accordance with DIN EN ISO 13934-1, in the range of from 200 Newtons to 4,000 Newtons;
(vi) the protective material has an elongation load in at least one direction, determined in accordance with DIN 53835-14 at 20 Newton, of at least 2.5%;
(vii) the protective material has a shrinkage in at least one direction, determined in accordance with DIN EN 5077, of at most 10%.

82. The method according to claim 71,
wherein the protective clothing fulfills at least one of the following characteristics (i) to (vii):
(i) the protective clothing has a gas permeability at a flow resistance of 100 Pascal, determined in accordance with DIN EN ISO 9237, in the range of from 0.5 mm/s to 500 mm/s;
(ii) the protective clothing has a water vapor transmission resistance Ret, determined in accordance with DIN EN 343:2019, of at most 15 m² Pa/Watt;
(ili) the protective clothing has a thickness in the range of from 0.25 mm to 25 mm, determined in accordance with DIN EN ISO 5084;
(iv) the protective clothing has a burst pressure, determined in accordance with DIN EN ISO 13938-2, in the range of from 50 kPa to 1,000 kPa;
(v) the protective clothing has a maximum tensile force in at least one direction, determined in accordance with DIN EN ISO 13934-1, in the range of from 200 Newtons to 4,000 Newtons;
(vi) the protective clothing has an elongation load in at least one direction, determined in accordance with DIN 53835-14 at 20 Newton, of at least 2.5%;
(vii) the protective clothing has a shrinkage in at least one direction, determined in accordance with DIN EN 5077, of at most 10%.

83. The method according to claim 71,
wherein the adsorbent particles of the adsorption layer are selected from the group consisting of
(i) activated carbon particles selected among activated carbon particles in granular form, activated carbon particles in spherical form and activated carbon particles in fibrous form;
(ii) zeolite particles;
(iii) molecular sieve particles;
(iv) metal oxide particles and metal particles;
(v) ion exchange resin particles;
(vi) inorganic oxide particles;
(vii) porous organic polymer particles, porous organic-inorganic hybrid polymer particles and porous metal-organic framework material particles;
(viii) mineral granulate particles;
(ix) clathrate particles; and
(x) their mixtures and combinations.

84. The method according to claim 71,
wherein the adsorbent particles of the adsorption layer are selected from the group consisting of activated carbon particles selected among activated carbon particles in granular form, activated carbon particles in spherical form and activated carbon particles in fibrous form.

85. The method according to claim 71,
wherein at least one of the protective material and the protective clothing is provided with at least one of a flame-retardant finish and a flame-resistant finish.

86. The method according to claim 71,
wherein the method comprises the protection of a person that is equipped with the protective clothing against gases containing polycyclic aromatic hydrocarbons.

87. The method according to claim 71,
wherein the method comprises the protection of a person that is equipped with the protective clothing against gases containing polycyclic aromatic hydrocarbons selected among exhaust gases and flue gases from combustion and high-temperature processes, gases and flue gases from and in fires, coking plants, foundries, steelworks, smelting processes, metal- and steel-production and processing processes, blast furnace processes, waste incineration processes, asphalt-production and asphalt-processing processes, glass-production and glas-processing processes and refractory-production and refractory-processing processes.

88. The method according to claim 71,
wherein the polycyclic aromatic hydrocarbons originate from gases from combustion and high-temperature processes.

89. The method according to claim 71,
wherein the person that is to be protected is selected from the group consisting of firefighters and persons working in coking plants, foundries, steelworks, smelting processes, metal- and steel-production and processing processes, blast furnace processes, waste incineration processes, asphalt-production and asphalt-processing processes, glass-production and glass-processing processes and refractory-production and refractory-processing processes.

90. A protective clothing for protecting a person that is exposed to polycyclic aromatic hydrocarbons against a contamination with said polycyclic aromatic hydrocarbons,
wherein the protective clothing is in the form of a protective undergarment,
wherein the protective clothing comprises a textile protective material,
wherein the textile protective material is a multi-layered textile composite material comprising a plurality of interconnected layers,
wherein the textile protective material comprises the following layers in the sequence mentioned as follows:
(a) a textile support layer, wherein the textile support layer is configured as a gas-permeable textile sheet-structure,
(b) an adhesive layer applied to one side of the textile support layer, wherein the adhesive layer is configured as a water-vapor-permeable and gas-permeable and discontinuously formed adhesive layer,
(c) an adsorption layer fixed to the adhesive layer, wherein the adsorption layer comprises a plurality of individual adsorber particles,
(d) a particle- and aerosol-filter layer arranged on the adsorption layer, wherein the particle- and aerosol-filter layer is configured as a gas-permeable textile sheet-structure comprising a plurality of individual textile fibers;
wherein the protective clothing is configured in the form of a combination of mutually complementary pieces of protective undergarment, wherein the combination is configured to protect the lower body, the upper body and the head.

91. The protective clothing according to claim 90,
wherein the protective clothing is configured in the form of a combination of mutually complementary pieces of protective undergarment, wherein the combination comprises (i) a protective leg garment, (ii) a protective top garment including covering of the arms and (ill) a protective headwear.

92. The protective clothing according to claim 90,
wherein the textile protective material further comprises the following layer:
(e) a cover layer arranged on the particle- and aerosol-filter layer, wherein the cover layer is configured as a gas-permeable textile sheet-structure.

93. A protective clothing combination for protecting a person that is exposed to polycyclic aromatic hydrocarbons against a contamination with said polycyclic aromatic hydrocarbons,
wherein the protective clothing combination comprises:
(A) a protective outerwear; and
(B) a protective clothing in the form of a protective undergarment, wherein the protective clothing
wherein the protective clothing comprises a textile protective material,
wherein the textile protective material is a multi-layered textile composite material comprising a plurality of interconnected layers,
wherein the textile protective material comprises the following layers in the sequence mentioned as follows:
(a) a textile support layer, wherein the textile support layer is configured as a gas-permeable textile sheet-structure,
(b) an adhesive layer applied to one side of the textile support layer, wherein the adhesive layer is configured as a water-vapor-permeable and gas-permeable and discontinuously formed adhesive layer,
(c) an adsorption layer fixed to the adhesive layer, wherein the adsorption layer comprises a plurality of individual adsorber particles,
(d) a particle- and aerosol-filter layer arranged on the adsorption layer, wherein the particle- and aerosol-filter layer is configured as a gas-permeable textile sheet-structure comprising a plurality of individual textile fibers;
wherein the protective clothing is configured in the form of a combination of mutually complementary pieces of protective undergarment, wherein the combination is configured to protect the lower body, the upper body and the head.

94. The protective clothing combination according to claim 93,
wherein the protective clothing is configured in the form of a combination of mutually complementary pieces of protective undergarment, wherein the combination comprises (i) a protective leg garment, (ii) a protective top garment including covering of the arms and (iii) a protective headwear.

95. The protective clothing combination according to claim 93,
wherein (B) the textile protective material further comprises the following layer:
(e) a cover layer arranged on the particle- and aerosol-filter layer, wherein the cover layer is configured as a gas-permeable textile sheet-structure.

96. The protective clothing combination according to claim 93,
wherein (A) the protective outerwear is selected from the group consisting of protective workwear, personal protective outer equipment and protective outerwear for firefighters.

97. A method for protecting a person that is exposed to polycyclic aromatic hydrocarbons against a contamination with said polycyclic aromatic hydrocarbons,
wherein the method comprises a step of equipping the person that is to be protected with a protective clothing combination;
wherein the protective clothing combination comprises:
(A) a protective outerwear; and
(B) a protective clothing in the form of a protective undergarment, wherein the protective clothing comprises a textile protective material,
wherein the textile protective material is a multi-layered textile composite material comprising a plurality of interconnected layers,
wherein the textile protective material comprises the following layers in the sequence mentioned as follows:
(a) a textile support layer, wherein the textile support layer is configured as a gas-permeable textile sheet-structure,
(b) an adhesive layer applied to one side of the textile support layer, wherein the adhesive layer is configured as a water-vapor-permeable and gas-permeable and discontinuously formed adhesive layer,
(c) an adsorption layer fixed to the adhesive layer, wherein the adsorption layer comprises a plurality of individual adsorber particles,
(d) a particle- and aerosol-filter layer arranged on the adsorption layer, wherein the particle- and aerosol-filter layer is configured as a gas-permeable textile sheet-structure comprising a plurality of individual textile fibers;
wherein the protective clothing is configured in the form of a combination of mutually complementary pieces of protective undergarment, wherein the combination is configured to protect the lower body, the upper body and the head.
